(19) United States
(12) Patent Application Publication
(10) Pub. No.: US 2003/0187688 A1
(43) Pub. Date: Oct. 2, 2003

(54) Method, system and computer program for health data collection, analysis, report generation and access

(76) Inventors: Christopher T. Fey, Jacksonville, FL (US); Fred W. Fey, Ponte Verdra Beach, FL (US); Kathy M. Fleming, Ponte Vedra Beach, FL (US); John W. Franks, Jacksonville, FL (US); Paul S. Kasinski, Jacksonville, FL (US); Heather L. Staves, Jacksonville, FL (US); Eduardo J. Balbona, Jacksonville, FL (US); Noel C. Khirsukhani, Jacksonville, FL (US); Kevin M. Oyler, Fernindina Beach, FL (US); Enrico A. Discacciati, Jacksonville, FL (US); Danielle C. Renfro, Jacksonvillie, FL (US); Leah M. Nelms, Jacksonvillie, FL (US); Staci J. Presley, Jacksonville, FL (US); Scott Coster, Jacksonvillie, FL (US)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 09/792,101

(22) Filed: Feb. 23, 2001

Related U.S. Application Data
(60) Provisional application No. 60/185,045, filed on Feb. 25, 2000.

(51) Int. Cl. G06F 17/60

(52) U.S. Cl. 705/2

(57) ABSTRACT

A health data management system is provided. Specifically, the invention includes a system and method for collecting screening, diagnostic, and demographic data from clients, processing and analyzing health data from health risk assessments and screening tests, generating custom reports, maintaining heath data, pre-populating data into user accessible personal health records and aggregate data for scientific research and clinical studies. The invention can be implemented in numerous ways, including as a system, a device, a method, or a computer readable medium.

### CROSS-REFERENCE TO RELATED APPLICATIONS

This application claims priority from U.S. provisional application, serial No. 60/185,045, filed Feb. 25, 2000, the disclosure of which is incorporated herein by reference in its entirety.

### FIELD OF THE INVENTION

The present invention relates to health data management. Specifically, the invention relates to a system and method for collecting screening, diagnostic, and demographic data from clients, processing and analyzing health data from health risk assessments and screening tests, generating custom reports, maintaining heath data, pre-populating data into user accessible personal health records and aggregate data for scientific research and clinical studies.

### BACKGROUND OF THE INVENTION

The diseases that kill most Americans are silent thieves, leaving few clues that they are robbing individuals of good health. By the time symptoms appear, the disease is often in an advanced, sometimes fatal, stage.

Heart disease is the number one killer of adults in America. While most heart patients have no warning prior to their first heart attack, the health community now recognizes that the buildup of plaque in coronary arteries is responsible for all heart attacks. Yet, plaque does not occur overnight. It builds up over time—often as long as 10 to 20 years—before becoming severe enough to block the coronary arteries, leading to a heart attack. Traditional stress tests detect plaque in very advanced stages, when there is more than 70% blockage. Yet, 68% of heart attacks occur when blockage is less than 50%. Early detection can lead to lifestyle changes and preventive treatment, saving lives and millions of dollars in intensive care treatment.

Cancer is the number two killer of adults in our country. Early detection often makes the difference between survival and fatality. Pre-cellular changes leading to cancer often occur in the body up to 10 years prior to the formation of a tumor. While early detection strategies are common for cancers of the breast, colon and prostrate, no early detection strategy for lung cancer is widely utilized. Yet, lung cancer will kill more Americans than all of the above-mentioned cancers combined. Recent studies show the use of low-dose CT Scan can detect four times the number of lung cancers as compared to traditional chest x-rays. Moreover, these cancers are six times as likely to be discovered at the earliest stage (Stage 1) when the chances for a cure are best. Yet most insurance carriers do not cover the cost of early detection screening for lung cancer. While insurance companies may authorize chest x-rays, standard x-rays do not differentiate between irregular nodules less than two centimeters in the lungs. Detection when the nodule is less than two centimeters increases lung cancer survival rates from 20% to 80%. Again, early detection and accurate risk assessment can lead to preventive treatment and positive lifestyle changes for those not yet dealing with full-blown cancer. For those with malignant tumors, early detection while tumors are small and localized greatly increases survival rates and quality of life for those survivors.

Insurance companies, faced with exploding costs, feel a fiscal responsibility to wait for irrefutable proof that a particular screening test saves a substantial number of lives before authorizing its use. “There are 90 million smokers in this country. If they all want a CT lung scan every year, it would cost $400 each—and that's a big number,” said Allan Kom, chief medical officer for Blue Cross/Blue Shield Association. “We're still studying whether it would make a difference in overall survival” (qtd. in USA Today, May 25, 2000). Typically, studies determining that level of proof take 10 to 15 years and are dependent upon funding to complete. In fact, NCI is beginning a 15-year study of 100,000 clinical trial subjects. Millions of individuals will die of lung cancer awaiting the results. Consumers, many of whom are aging baby-boomers, demand more control over their health care and more immediate access to potentially life-saving health screening.

In addition, our society is a mobile one. Families move an average of 8 times and no longer see the same general practitioner throughout their lives. Many adults travel on business and pleasure. There is a need for quick access to medical records should an emergency arise while away from home. Millions of Americans are covered under HMOs. If their primary care or specialty physicians leave the health care network, these consumers must transfer their records to newly-assigned physicians. Often transferring records involves a fee and an extended wait time, up to several weeks. In addition, many physicians are compelled to get authorizations for most tests and may face stringent limitations when ordering tests. A-symptomatic patients are rarely given authorizations for many potentially life-saving screening tests.

All of these factors point to a pressing need for a system and method that encourages wellness care through health screening tests available directly to consumers, secure storage of those tests' results, and lifelong storage of health records. Further, there is a need for immediate access of those records by the client and attending physician. There is a need for custom reports generated at the time tests are performed and additional reports generated as needed. There is a need for an educational component to the reports that explains the results, the risk assessment, resources available to learn more and, possibly, lifestyle recommendations based on the results. An added benefit of this needed system, method and computer program is the compilation of tremendous data accumulated on a largely pre-symptomatic population. Such data can be used not only to analyze medical trends but can provide proof of the effectiveness of health screenings when accompanied by full explanations of the results and educational resources to learn more about potential conditions, prevention, wellness programs and treatment options.

While a number of patents have been issued dealing with medical databases and patient information, all have been solely for use by the medical community. Thus, the consumer does not experience greater control over individual health. In addition, the medical databases are primarily based upon data from symptomatic patients, rather than a population more reflective of the general population.

U.S. Pat. No. 6,014,630 to Jeacock & Nowak is comprised of a database system of various medical procedures, practices of individual physicians, methods followed by various medical facilities and a program to select desired ones for a particular patient with the capability of modification by the doctor. The program produces a personalized patient document that explains the procedure and follow-up care. While the document produced is educational for the patient, it is limited to one particular treatment by a specific doctor. The stated purpose is to protect the physician and facility from a malpractice suit due to lack of patient knowledge or understanding. It is not intended to increase a patient's control over health or to educate the patient on preventive care techniques to enhance wellness.

U.S. Pat. No. 6,151,581 to Kraftson, et al is for a system and method of collecting and populating a database with physician/patient data for processing to improve practice and quality healthcare. This invention seeks to build and administer a patient management and health care management database through the use of surveys to analyze the quality of care. While this invention seeks to improve patient care through the collection of data, the data relied upon is based solely upon a variety of surveys, thus is subjective rather than objective. It is also intended for the exclusive use of the medical community, not the individual consumer.

U.S. Pat. No. 5,796,759 to Eisenberg, et al is for a system and method for assessing the medical risk of a given outcome for a patient. The method comprises obtaining test data from a given patient corresponding to at least one test marker for predicting the medical risk of a patient and transforming the data with the variable to produce transformed data for each of the test markers. The transformed data is compared with the mean and standard deviation values to assess the likelihood of the given outcome for the given patient and the database is updated with the actual occurrence for the given patient, whereby the determined mean and standard deviation will be adjusted. The patent does provide a basis for risk assessment that is constantly updated as data changes. However, it is limited to already symptomatic patients undergoing treatment —in this case, maternity patients. It provides a useful tool for the medical community regarding high-risk pregnancies but cannot be used to predict overall health trends among the general population. It also does not incorporate a program to educate the consumer or inform the consumer of possible preventive care or lifestyle changes to minimize risk.

Medical screening can locate problems early so individuals can take appropriate action. However, the results of most lab reports are incomprehensible by most consumers and are often sent directly to doctors without even informing consumers of the results.

Moreover, data from such screenings is often not collected, saved, analyzed or utilized by consumers, doctors, or research organizations which could benefit from such pre-symptomatic heath screening data and demographics associated therewith.

Therefore, there is a need in the art for a method by which consumers can take charge of their health. There is also a need in the art for consumers to be able to receive and comprehend data from their screenings and maintain such data as a life-long health record. There is a need for such a record to be readily accessed and updated. There is also a need for the ability to collect, analyze and maintain aggregate pre-symptomatic heath and demographic data for scientific research which may ultimately lead to the prevention and cure for disease.

### Brief Summary of the Invention

The present invention solves the above-stated problems in the art by providing a system and method for screening clients, collecting screening and demographic data therefrom, processing and analyzing the data, generating custom reports, maintaining heath data, and providing electronic user access to personal health records.

Features of the invention can be implemented in numerous ways, including as a system, a method, a computer site, or a computer readable medium. The invention preferably relies on a communications infrastructure, for example the Internet, wherein individual interaction is possible. Several embodiments of the invention are discussed below.

As a computer system, part of the invention generally includes a database and a processor unit. The processor unit operates to receive information (health and demographic) about an individual and to analyze the received information in conjunction with the statistical/known information (e.g., disease symptoms, risk factors, blood studies, screening factors) to generate customized detailed reports both for the individual and his physician. The reports may include print or electronic media.

The printed report preferably includes results from the screening with analysis and recommendations as well as a summary for the physician.

Part or all of the data can also be sent electronically or telephonically, with devices such as fax back, and maintained on a web server for confidential access with typical browsers. The data may be accessed or sent to medical practitioners or others at the discretion and direction of the consumer. The health and demographic data collected from the screening can pre-populate a life-long health record to avoid the need for the consumer to complete long medical information forms. The data may also be transmitted and viewed by other well known techniques such as email, interactive television, and the like. The computer site is preferably viewed with a client web browser as an HTML document through a web secure server communicating with an application server having a database associated therewith.

Screening test results may be used in conjunction with carefully formatted health risk assessment questionnaires which identify increased risks associated with social habits and behaviors as well as personal health history and familial history to better assess the individual consumer's risk and identify whether that individual may qualify to participate in and benefit from a specific clinical study. In addition, the aggregate data can be used to forecast trends and evaluate medical probabilities based on a population that more closely matches the general population. Questions in the health risk assessment should be based upon findings from prior scientific studies such as the Framingham study and/or reliable sources recognized by the medical community such as the American Heart Association and the American Cancer Association.

As a computer readable medium containing program instructions for collecting, analyzing and generating output, an embodiment of the invention includes computer readable code devices for interacting with a consumer as noted above, processing that data in conjunction with analytical information, and generating unique printed or electronic media for that consumer.

As screening data is collected from individual consumers, the aggregate of information may also be maintained and utilized for scientific research.

The advantages of the invention are numerous. First and foremost, the invention provides for a method by which consumers can take charge of their health, allowing them to receive and comprehend data from their screenings and maintain such data as a life-long health record. Linking the screening phase to the on-line health record provides the consumer with an easier means to begin and maintain such a health record by pre-populating a majority of the data fields from data already collected during the screening process. A resulting advantage is the ability to collect, analyze and maintain aggregate pre-symptomatic heath and demographic data for scientific research.

Other aspects and advantages of the invention will become apparent from the following detailed description taken in conjunction with the accompanying drawings, illustrating by way of example the principles of the invention.

All patents, patent applications, provisional applications, and publications referred to or cited herein, or from which a claim for benefit of priority has been made, are incorporated herein by reference in their entirety to the extent they are not inconsistent with the explicit teachings of this specification. The following patents are incorporated herein by reference: U.S. Pat. No. 6,154,726 to Rensimer, U.S. Pat. No. 6,151,581 to Kraftson, U.S. Pat. No. 6,148,297 to Swor, U.S. Pat. No. 6,144,837 to Quy, U.S. Pat. No. 6,022,315 to Iliff, U.S. Pat. No. 6,018,713 to Coli, U.S. Pat. No. 6,017,307 to Raines, U.S. Pat. No. 6,016,497 to Suver, U.S. Pat. No. 6,014,630 to Jeacock, U.S. Pat. No. 6,014,626 to Cohen, U.S. Pat. No. 6,002,915 to Shimizu, U.S. Pat. No. 5,995,937 to DeBusk, U.S. Pat. No. 5,991,731 to Colon, U.S. Pat. No. 5,991,730 to Lubin, U.S. Pat. No. 5,987,434 to Libman, U.S. Pat. No. 5,941,820 to Zimmerman, U.S. Pat. No. 5,924,074 to Evans, U.S. Pat. No. 5,890,129 to Spurgeon, U.S. Pat. No. 5,796,759 to Eisenberg, and U.S. Pat. No. 4,315,309 to Coli.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an overall system block diagram of a preferred embodiment of the present invention.

FIG. 2 is a system flow diagram of a preferred embodiment of the present invention.

FIG. 3 is a hardware diagram of a preferred embodiment of the present invention.

FIG. 4 is an entity relationship model for a preferred embodiment of the present invention.

FIGS. 5A-5B are flow charts of the operation of a preferred embodiment of the present invention.

FIGS. 6A-6N are process and flow diagrams of a preferred embodiment of the present invention.

FIGS. 7A-7W represent a sample client report generated by a preferred embodiment of the present invention.

FIGS. 8A-8H represent a sample group summary report generated by a preferred embodiment of the present invention.

FIG. 9 represents one sample aggregate information report generated by a preferred embodiment of the invention.

Appendix A included at the end of this description is a CD-ROM and printout containing the source code and script for making and using one embodiment of the present invention.

It should be understood that in certain situations for reasons of computational efficiency or ease of maintenance, the ordering of the blocks of the illustrated flow charts could be rearranged or moved inside or outside of the illustrated loops by one skilled in the art. While the present invention will be described with reference to the details of the embodiments of the invention shown in the drawing, these details are not intended to limit the scope of the invention.

### DETAILED DISCLOSURE OF THE INVENTION

Reference will now be made in detail to the embodiments consistent with the invention, examples of which are illustrated in the accompanying drawings. Wherever possible, the same reference numerals used throughout the drawings refer to the same or like parts.

The present invention solves the problems in the art by providing a system and method for screening clients, collecting screening and demographic data therefrom, processing and analyzing the data, generating custom reports, maintaining heath data, and providing electronic user access to personal health records. Preferably, the invention is operated in conjunction with an interactive web site.

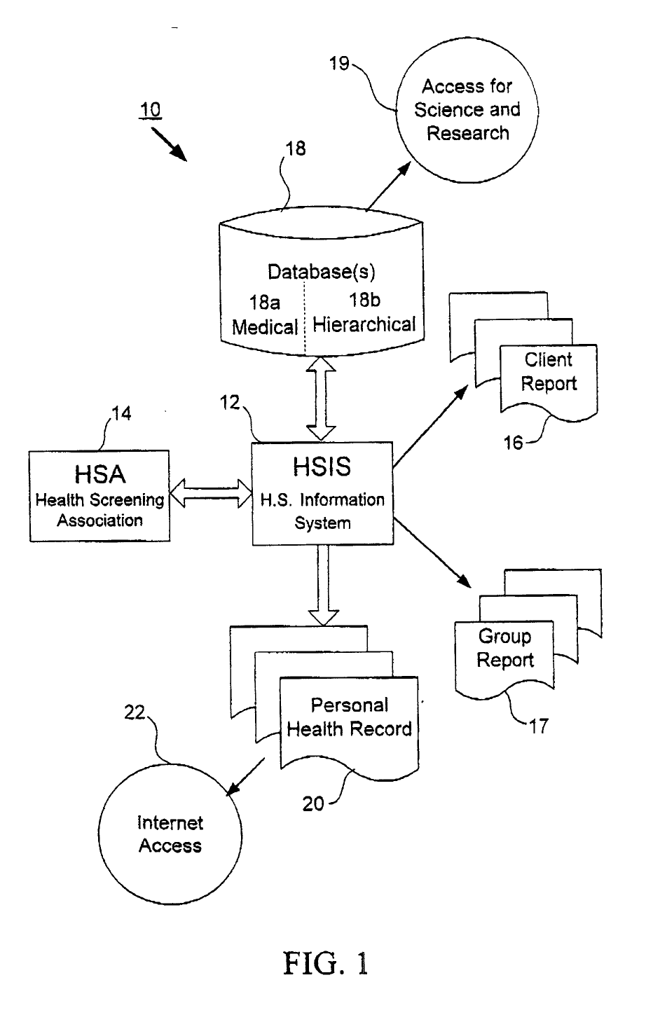

FIG. 1 shows an overall system block diagram of a preferred embodiment of the present invention. Central to the health data management system 10 is the Health Screening Information System (HSIS) 12 which is associated with a Health Screening Association (HSA) 14 to carry out the aspects of the present invention. The HSA may consist of various clinics, mobile units, screening facilities, and the like which provide for screening of clients, and collecting screening and demographic data therefrom. The HSA 14 communicates with the HSIS 12 for processing and analyzing the data. Custom reports are generated, both at the client level in the form of a client report 16 and at a collective level in the form of a group report 17. The system data is maintained in a database 18. This data may be accessed in aggregate form by various institutions and researchers 19 for scientific research. The system also provides for user access to electronic personal health records 20 via the Internet 22 or other electronic communication means (such as fax back system).

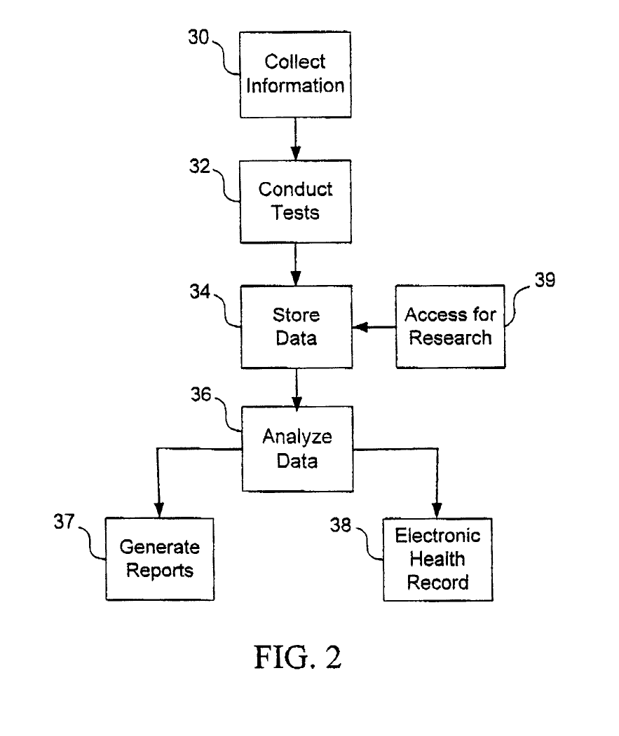

A brief overview of the system will now be described with reference to the process shown in FIG. 2. Initially, demographic information is collected about the consumer in step 30. Health screening tests are also conducted to collect health data in step 32. This data is input into the system in step 34 manually or directly from the screening devices. This health and demographic data is analyzed in step 36 in conjunction with known medical/statistical data (e.g., disease symptoms, risk factors, blood studies, screening factors). The system may utilize various algorithms, real-time learning and inference technology, profiling, pattern recognition learning algorithms, neural networks, and the like in order to correlate medical/statistical information with the collected data. The necessary medical/statistical information can be gathered from various known sources or acquired and continuously updated as the database acquires information from each new consumer.

After the software of the present invention analyzes the health screening and demographic data, the next step in the process is to generate in real-time a report for the individual consumer in step 37 (or for a group of consumers, e.g., a workplace). The personalized health record reviews individualized health risks and thoroughly explains test results with follow-up recommendations. Furthermore, a personalized health assessment is provided to determine further health risks.

The present invention also utilizes the consumer's information to pre-populate a “life-long health record” accessible on the Internet (or other communication means such as, but not limited to a fax back system) in step 38. This record stores the test results, plus medical history including allergies, medications, immunizations, insurance and physician information. From this site, consumers can store, retrieve and analyze personal medical data about themselves and their family in a secure environment. The site allows consumers to track their own health progress and tap into a huge library of medical information. Each time a consumer is screened, the results will be added to the site. The results may also be made available to consumers by other electronic communication means such as facsimile devices, e-mail, and the like.

The aggregate of collected health and demographic information is also maintained on the system. This information can be access in step 49 and utilized by doctors and researchers to discover trends, conduct scientific research, and study pre-symptomatic health data.

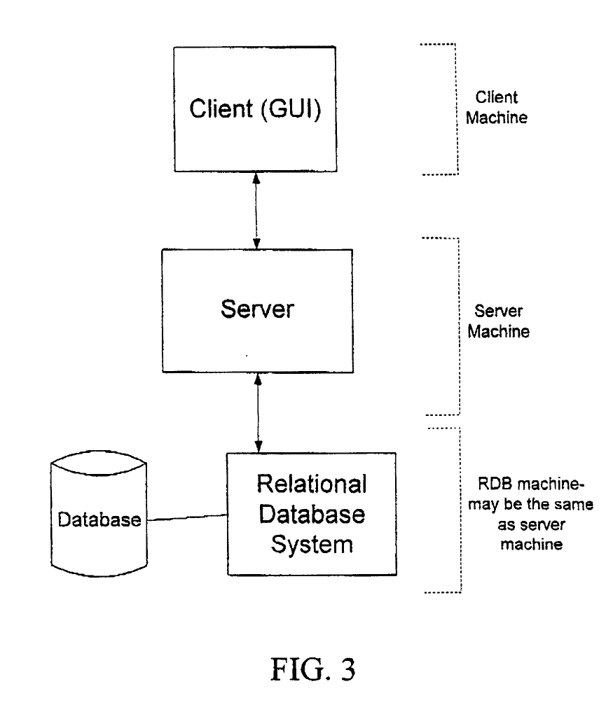

FIG. 3 shows the preferred architecture of the present invention. The system comprises at least two networked computer processors (client component(s) for input and server component(s)) and a database(s) for storing data. The computer processors can be processors that are typically found in personal desktop computers (e.g., IBM, Dell, Macintosh), portable computers, mainframes, minicomputers, or other computing devices. Preferably in the networked client/server architecture of the present invention, a classic two or three tier client server model is utilized. Preferably, a relational database management system (RDMS), either as part of the Application Server component or as a separate component (RDB machine) provides the interface to the database.

In a preferred database-centric client/server architecture, the client application generally requests services from the application server which makes requests to the database (or the database server). The server(s) (e.g., either as part of the application server machine or a separate RDB/relational database machine) responds to the client's requests.

More specifically, the input client components are preferably complete, stand-alone personal computers offering a full range of power and features to run applications. The client component preferably operates under any operating system and includes communication means, input means, storage means, and display means. The user enters input commands into the computer processor through input means which could comprise a keyboard, mouse, or both. Alternatively, the input means could comprise any device used to transfer information or commands. The display comprises a computer monitor, television, LCD, LED, or any other means to convey information to the user. In a preferred embodiment, the user interface is a graphical user interface (GUI) written for web browser applications.

The server component(s) can be a personal computer, a minicomputer, or a mainframe and offers data management, information sharing between clients, network administration and security. The Database Server (RDBMS—Relational Database Management System) and the Application Server may be the same machine or different hosts if desired.

The present invention also envisions other computing arrangements for the client and server(s), including processing on a single machine such as a mainframe, a collection of machines, or other suitable means. The client and server machines work together to accomplish the processing of the present invention.

The database(s) is preferably connected to the database server component and can be any device which will hold data. For example, the database can consist of any type of magnetic or optical storing device for a computer (e.g., CDROM, internal hard drive, tape drive). The database can be located remote to the server component (with access via modem or leased line) or locally to the server component.

The database is preferably a relational database that is organized and accessed according to relationships between data items. The relational database would preferably consist of a plurality of tables (entities). The rows of a table represent records (collections of information about separate items) and the columns represent fields (particular attributes of a record). In its simplest conception, the relational database is a collection of data entries that “relate” to each other through at least one common field.

### DESCRIPTION OF PREFERRED EMBODIMENT

For convenience, the description of the preferred embodiment comprises three sections: the overview and architecture of the system, method and program; the process used with the individual consumer and the organization; and the storage of the demographic and screening information for analysis and report generation.

I. OVERVIEW AND ARCHITECTURE OF THE SYSTEM, METHOD AND PROGRAM

Returning to FIG. 1, at the center of the architecture is a computer system (Health Screening Information System 12) with an associated database 18 used for storage of the demographic and screening data, multiple informational tables and educational information. Test results and pertinent information from the tables may be included in a client test result report as well as a variety of other reports issued upon request (e.g., client report 16, and group report 17). The database 18 is comprised of two databases: the primary, relational database 18a and a subsidiary, hierarchical database 18b that contains all the tables of information, including but not limited to normal ranges of test results and risk assessments. Accurate tables populated with the most current information available from the most reliable medical resources are essential. The subsidiary database 18b is more static and information is automatically pulled from there to populate specific fields in the reports generated in the primary database 18a which operates in real-time.

Appendix A is a CD containing all the source code and script used to create both databases 18a and 18b. The script in the preferred embodiment is written in SQL and the source code in Visual Basic, but they may be written in any combination of IBM-compatible computer languages capable of creating both hierarchical and relational, object-oriented databases with communication embedded between them. Report software may also be utilized. In the preferred embodiment, Seagate Crystal Reports and Microsoft Excel are utilized, but any database management tool or system that is SQL compatible may be used including, but not limited to, Oracle and DB2. When information is pulled from SQL, it is put into Crystal Report for report generation and information analysis.

Additional workstations equipped with computers and printers may be used at point of service (HSA 14) to enter demographic and screening data. The appropriate reports (e.g., client report 16 and group report 17) may be generated at or transmitted to the HSA 14. In the preferred embodiment, each computer at a permanent location has a shortcut on the desktop to the HSIS 12 that has a connection to the relational database 18a. Computers in mobile units are preferably not connected to the primary database 18a. Instead they are connected to a mobile server and use a merge replication to ensure autonomous function without a direct connection to the primary database. A production server is required for the permanent workstations. In the preferred embodiment, mobile units may be transported any place in the world because each unit contains a mobile server and medical testing equipment, shipped in carefully-fitted metal containers for safety and portability.

The subsidiary, hierarchical database 18b is essentially a lookup database. In the preferred embodiment, List Manager is used. Hierarchical logic is incorporated in the program. The tables are composed of tasks, categories, tests, expected results, and the format of the expected results. Each test attribute has a unique identification number (ID#) which corresponds to the event in the List Manager.

Since the medical database 18a contains consumers' health and information, strong security in the form of a firewall is preferred. In a more preferred embodiment, further security protection is incorporated. For example, each client is assigned an unique 14-digit identification number, rather than a more traceable identifier such as a Social Security number. Additional safeguards are also in place and will be discussed in the process section.

An Intranet or business network (ITP connection) is used to support the database 18 internally and an Internet web site accessible by all with several degrees of secured access is used to allow immediate, remote access to records and relevant educational information for both clients and physicians.

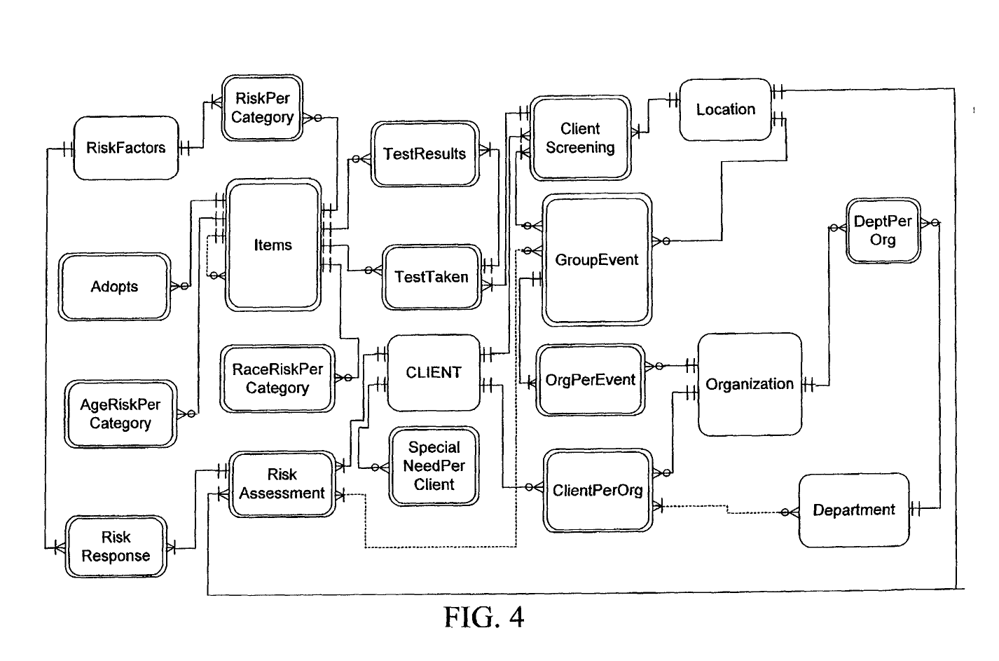

FIG. 4 shows the entity relation model for the preferred embodiment of the present invention, as further detailed in the following collection of tables (entities). The entities include: Risk Factors 41, Adopts 42, Age Risk Per Category 43, Risk Response 44, Risk Per Category 45, Items 46, Race Risk Per Category 47, Risk Assessment 48, Test Results 49, Test taken 50, Client 51, Special Need Per Client 52, Client Screening 53, Group Event 54, Org Per Event 55, Client Per Org 56, Location 57, Organization 58, Dept Per Org 59, and Department 60.

TABLE 1
Client.
This table will store all demographic
information pertaining to a client.

| | | DATA | |
|---|---|---|---|
| FIELD NAME | DATA TYPE | MASK | DESCRIPTION |
| Acct.Num | numeric | (9.0) | HSI account number- |
| | | | unique identifier for each |
| | | | client. Key = Primary |
| SocSec.Num | numeric | 4 | Social Security Number |
| Title | char;valueset | 32 | Title in client name |
| | | | (i.e., Mr., Ms., Dr.) |
| FirstName | varchar | 32 | First Name |
| MiddleName | varchar | 32 | Middle Name |
| LastName | varchar | 16 | Last Name |
| Suffix | varchar | 64 | Suffix in client name |
| | | | (i.e., Jr., Sr., III., MD) |
| Address1 | varchar | 64 | Primary client address |
| Address2 | varchar | | Secondary client address |
| City | varchar | | Client city |
| StateId | numeric | | Client State. Key = Foreign |
| | | | [State] |
| CountryId | numeric | | Client Country Key = |
| | | | Foreign [State] |
| Zip | numeric | (9.0) | Client Zip Code |
| HomePhone | numeric | (18.0) | Home phone number |
| WorkPhone | numeric | (18.0) | Work Phone number |
| MobilePhone | numeric | (18.0) | Cellular number |
| Pager | numeric | (18.0) | Client pager number |
| HomeFax | numeric | (18.0) | Home fax number |
| WorkFax | numeric | (18.0) | Work fax number |
| Email | varchar | 128 | Client e-mail |
| Gender | char; value set | 1 | Client gender |
| DOB | datetime | | Client birth date |
| RaceId | numeric | | Client Race. Key = Foreign |
| | | | [Race} |
| MailingList | boolean | | whether or not the client |
| | | | wants to be on our mailing |
| | | | list |
| HeardAboutUsId | numeric | | how the client heard about |
| | | | us. Key = Foreign |
| | | | [HeardAboutUs] |
| HealthCompass | varchar | 32 | HealthCompass Account |
| AcctNum | | | Number |

TABLE 2
Special Needs.
This table will store
the special needs choices for the client
(see lookup tables for values)

| FIELD NAME | DATA TYPE | LENGTH | DESCRIPTION |
|---|---|---|---|
| SpecialNeedId | numeric | | unique identifier for |
| | | | special need. Key = |
| | | | Primary |
| SpecialNeed | Varchar | 20 | |

TABLE 3
Special Need Per Client.
This table will store each special need a client has.

| FIELD NAME | DATA TYPE | LENGTH | DESCRIPTION |
|---|---|---|---|
| SpecialNeedID | numeric | | unique identifier for |
| | | | special need. Key = |
| | | | Primary Foreign |
| | | | [SpecialNeeds] |
| AcctNum | numeric | | unique identifier for |
| | | | each client. Key = |
| | | | Primary Foreign |
| | | | [Client] |
| Comment | varchar | 80 | comment. Key = |
| | | | Primary Foreign |
| | | | [Client] |

TABLE 4
State.
This table will store state choices
(see lookup tables for values)

| FIELD NAME | DATA TYPE | LENGTH | DESCRIPTION |
|---|---|---|---|
| StateId | numeric | | unique identifier for |
| | | | state. Key = Primary |
| StateAbbreviation | char | 2 | 2 letter state |
| | | | abbreviation |
| State | varchar | 64 | state name |

TABLE 5
Country.
This table will store race choices
(see lookup tables for values)

| FIELD NAME | DATA TYPE | LENGTH | DESCRIPTION |
|---|---|---|---|
| CountryId | numeric | | unique identifier for |
| | | | country. Key = |
| | | | Primary |
| Country | varchar | 64 | country name |

TABLE 6
Race.
This table will store race choices
(see lookup tables for values)

| FIELD NAME | DATA TYPE | LENGTH | DESCRIPTION |
|---|---|---|---|
| RaceId | numeric | | unique identifier for |
| | | | race. Key = |
| | | | Primary |
| Race | varchar | 32 | Race or nationality |

TABLE 7
Heard About Us.
This table will store the special needs
choices for the client (see lookup tables for values)

| FIELD NAME | DATA TYPE | LENGTH | DESCRIPTION |
|---|---|---|---|
| HeardAboutUsId | numeric | | unique identifier for |
| | | | how the client heard |
| | | | about us. Key = |
| | | | Primary |
| WhereHeard | text | 50 | Where the client |
| | | | heard about us |

TABLE 8
New HC Accounts.
This table will store new, pre-registered

| FIELD NAME | DATA TYPE | LENGTH | DESCRIPTION |
|---|---|---|---|
| HealthCompassAcct | varchar | 32 | HealthCompassAc- |
| | | | count Number. Key = |
| | | | Primary |
| HealthCompassReg | varchar | 32 | HealthCompass |
| Code | | | Registration Code |

TABLE 9
Organization.
This table will store all information pertaining to
employers, groups and event organers

| | DATA | | | |
|---|---|---|---|---|
| FIELD NAME | TYPE | LENGTH | DESCRIPTION | KEY |
| OrgId | numeric | | Unique identifier for | Primary |
| | | | each employer | |
| Name | varchar | 40 | Organization Name | |
| Address1 | varchar | 32 | Primary organization | |
| | | | address | |
| Address2 | varchar | 32 | Secndary organization | |
| | | | address | |

TABLE 9
Organization.
This table will store all information pertaining
to employers, groups and event organers

| | | | | |
|---|---|---|---|---|
| City | varchar | 32 | Organization city | |
| StateId | numeric | | Organization state | Foreign |
| | | | | [State] |
| CountryId | numeric | | Organization | Foreign |
| | | | country | [Country] |
| Zip | numeric | (9.0) | Organization zip | |
| | | | code | |
| Phone | numeric | (18.0) | Organizatio phoe | |
| | | | number | |
| ContactTitle | char;value | 4 | Title (Mr., Ms., | |
| | set | | etc.) Of contact at | |
| | | | organization | |
| ContactFirst | varchar | 32 | First name of | |
| | | | contact at organ- | |
| | | | ization | |
| ContactMiddle | varchar | 32 | Middle name of | |
| | | | contact at | |
| | | | organization | |
| ContactLast | varchar | 32 | Last name of | |
| | | | contact at organ- | |
| | | | ization | |
| ContactSuffix | varchar | 16 | Suffix of contact | |
| | | | at organization | |
| ContactJobTitle | varchar | 64 | Job title of | |
| | | | contac t at organ- | |
| | | | ization | |
| ContactPhone | numeric | (18.0) | Phone number of | |
| | | | contac t at | |
| | | | organization | |
| ContactFax | numeric | (18.0) | Fax number of | |
| | | | contact at organ- | |
| | | | ization | |
| ContactEmail | varchar | 128 | email of contact | |
| | | | at organization | |
| NumOfEmployees | numeric | | number of | |
| | | | employees the | |
| | | | organization has | |
| Comment | memo | | comments | |

TABLE 10
ClientPerOrg.
This table will store every organization
associated with a client

| FIELD | DATA | | | |
|---|---|---|---|---|
| NAME | TYPE | LENGTH | DESCRIPTION | KEY |
| AcctNum | numeric | | Unique identifier | Primary |
| | | | for each client | Foreign |
| | | | | [Client] |
| Orgld | numeric | | Unique identifier | Primary |
| | | | for each | Foreign |
| | | | organizationv | [Organization] |
| Employee | Boolean | | is the client an | |
| | | | employee of the | |
| | | | organization | |
| Deptld | numeric | | unique identifier | Foreign |
| | | | for departmnent | [Department] |
| StartData | datetime | | Start date of | |
| | | | employment | |
| EndDate | datetime | | End Date of | |
| | | | Employment | |

TABLE 11
Department. This table will store all information
pertaiing to an organization's departments.

| FIELD NAME | DATA TYPE | LENGTH | DESCRIPTION | KEY |
|---|---|---|---|---|
| Deptld | numeric | | Unique identifier | Primary |
| | | | for department | |
| DeptName | varchar | 32 | Name of | |
| | | | Department | |

TABLE 12
DeptPerOrg.
This table will store every department
associated with an organization

| FIELD | DATA | | | |
|---|---|---|---|---|
| NAME | TYPE | LENGTH | DESCRIPTION | KEY |
| Orgld | numeric | | Unique identifier | Primary |
| | | | for each | Foreign |
| | | | organization | [Organization] |
| DeptId | numeric | | Unique identifier | Primary |
| | | | for department | Foreign |
| | | | | [Department] |
| Employee | Boolean | | is the client an | |
| | | | employee of the | |
| | | | organization | |
| Deptld | numeric | | unique identifier | Foreign |
| | | | for departmnent | [Department] |
| StartData | datetime | | Start date of | |
| | | | employment | |
| EndDate | datetime | | End Date of | |
| | | | Employment | |

TABLE 13
Risk Assessment.
This table will store all information
pertaining to a risk assessment

| | DATA | | | |
|---|---|---|---|---|
| FIELD NAME | TYPE | LENGTH | DESCRIPTION | KEY |
| RiskAssessmentId | numeric | | unique identifier | Primary |
| | | | for each risk | |
| | | | assessment | |
| AcctNum | numeric | | Unique identifier | Foreign |
| | | | for each client | [Client] |
| GroupEventld | numeric | | Unique identifier | Foreign |
| | | | for each group | [Group |
| | | | event | Event] |
| LocationId | numeric | | unique identifier | Foreign |
| | | | for risk assess- | [Location] |
| | | | ment location | |
| StartTime | datetime | | Start time with | |
| | | | risk assessment | |
| EndTime | datetime | | End time of risk | |
| | | | assessment | |

TABLE 14
Location.
This table will store all information
about the location of events

| FIELD | DATA | | | |
|---|---|---|---|---|
| NAME | TYPE | LENGTH | DESCRIPTION | KEY |
| LocationId | numeric | | Unique identifier | Primary |
| | | | for each location | |
| Name | varchar | 64 | Location Name | |
| | | | (store, mobile unit) | |
| Address1 | varchar | 64 | Location address | |
| Address2 | varchar | 64 | Location address | Foreign |
| | | | | [Department] |
| City | varchar | 32 | Location city | |
| StateId | numeric | | Location State | |
| CountryId | numeric | | Location Country | |
| Zip | numeric | (9.0) | Location zip code | |
| Phone | numeric | (18.0) | Location phone | |
| | | | number | |
| Fax | numeric | (18.0) | Location Fax | |
| HSILocation | Boolean | | Is this an HSI | |
| | | | location | |

TABLE 15
Risk Response. This table will store
the responses to the risk assessment

| | DATA | | |
|---|---|---|---|
| FIELD NAME | TYPE | DESCRIPTION | KEY |
| RiskAssessmen | numeric | Unique Id for risk | Primary Foreign |
| Id | | assessment | [RiskAssessment] |
| RiskId | numeric | Unique identifier for risk | Primary Foreign |
| | | factor | [RiskFactors] |
| Response | Boolean | response to risk | |
| | | assessment question | |

TABLE 16
Risk Factors. This table will store
the risk factors for the risk assessment

| | DATA | RANGE/ | | |
|---|---|---|---|---|
| FIELD NAME | TYPE | VALUES | LENGTH | DESCRIPTION |
| RiskId | numeric | | | Unique identifier |
| | | | | for risk factor. |
| | | | | Key = Primary |
| RiskQuestion | varchar | | 80 | Risk assessment |
| | | | | question |
| NegativeRiskFactor | varchar | | 64 | Negative Risk |
| | | | | factor |
| PositiveRiskFactor | varchar | | 64 | Positive Risk |
| | | | | Factor |
| Gender | char; | M/F | | applicable gender |
| | value | | | |
| | set | | | |
| Status | Boolean | Yes/No | | Status of risk |
| | | | | factor |

TABLE 17
Risk Per Category. This table will store
the risk/category matrix

| FIELD NAME | DATA TYPE | DESCRIPTION | KEY |
|---|---|---|---|
| RiskId | numeric | Unique identifier for | Primary Foreign |
| | | risk factor | [RiskFactors] |
| CategoryId | numeric | Unique identifier for | Primary Foreign |
| | | category from list | [ListMan][Items] |
| | | manager from List | |
| | | Categories | |

TABLE 18
Age Risk Per Category.
This table will store the risk/category matrix

| | DATA | RANGE/ | | |
|---|---|---|---|---|
| FIELD NAME | TYPE | VALUES | DESCRIPTION | KEY |
| CategoryId | numeric | | Unique identifier for | Primary |
| | | | category from list | Foreign |
| | | | manager from List | [ListMant] |
| | | | Categories | [Items] |
| RiskAge | numeric | | Age when you are | Primary |
| | | | at risk | |
| RiskGender | Char; | M/F | gender at risk | Primary |
| | value set | | | |
| Status | Boolean | Yes/No | status of risk factor | |

TABLE 19
Race Risk Per Category.
This table will store the face risk/category matrix.

| | DATA | RANGE/ | | |
|---|---|---|---|---|
| FIELD NAME | TYPE | VALUE | DESCRIPTION | KEY |
| CategoryId | numeric | | Unique identifier for | Primary |
| | | | category from list | Foreign |
| | | | manager from List | [ListMan] |
| | | | Categories | [Items] |
| RaceId | numeric | | race identifier from | Primary |
| | | | list manager from | Foreign |
| | | | List LimitToList, | [ListMan[ |
| | | | Race | [Items] |
| Status | Boolean | Yes/No | status of risk factor | |

TABLE 20
Client Screening.
This table will store all information
pertaining to a client screening

| | DATA | | |
|---|---|---|---|
| FIELD NAME | TYPE | DESCRIPTION | KEY |
| ScreeningId | numeric | Unique identifier for | Primary |
| | | client screening | |
| AcctNUM | | Unique identifier for | Foreign |
| | | each client | [Client] |
| GroupEventId | numeric | Unique identifer for | Foreign |
| | | screening group event | [GroupEvent] |
| LocationId | numeric | Unique identifier for | Foreign |
| | | screening location | [Location] |
| StartTime | datetime | Start time of screening | |
| EndTime | datetime | End time of screening | |
| AppointmentType | numeric | appointment type from | Foreign |
| | | list man from | [ListMan] |
| | | ListLimitToList, | [Items] |
| | | AppointmentType | |
| PreTaxPaid | numeric | pre tax paid amount | |
| Comment | memo | comments for the exit | |
| | | interview | |

TABLE 21
GroupEvent.
This table will store the information
about group organized events

| FIELD NAME | DATA TYPE | LENGTH | DESCRIPTION |
|---|---|---|---|
| GroupEventId | numeric | | Unique identifier for a |
| | | | group event. Key = |
| | | | Primary |
| EventName | char | 64 | Name of group event. |
| Locationld | numeric | | Unique identifier for a |
| | | | group event location. |
| | | | Key = Foreign [Location] |
| StartDate | datetime | | Start date of event |
| EndDate | datetime | | End date for event |
| ContactTitle | char; value set | 4 | Title of contact, (Mr. |
| | | | Ms.) For event |
| ContactFirst | varchar | 32 | First name of contact for |
| | | | event |
| ContactMiddle | varchar | 32 | Middle name of contact |
| | | | for event |
| ContactLast | varchar | 32 | Last name of contact for |
| | | | event |
| ContactSuffix | varchar | 16 | Suffix of contact for |
| | | | event |
| ContactJobTitle | varchar | 64 | Job title of contact for |
| | | | event |
| ContactPhone | numeric | (18.0) | Event contact phone |
| | | | number |
| ContactFax | numeric | (18.0) | Event contact fax number |
| ContactEmail | varchar | 128 | Event contact email |
| Comment | memo | | comments |

TABLE 22
Org. Per Event.
This table stores every organization
hosing a group event

| FIELD NAME | DATA TYPE | DESCRIPTION | KEY |
|---|---|---|---|
| GroupEventid | numeric | Unique identifier for | Primary Foreign |
| | | group event | [GroupEvent] |
| OrgId | numeric | Unique identifier for | Primary Foreign |
| | | each organization | [Organization] |

TABLE 23
Test Taken.
This table will store the comon test
information for tests that a client takes.

| | DATA | | |
|---|---|---|---|
| FIELD NAME | TYPE | DESCRIPTION | KEY |
| TestTakenId | numeric | Unique identifier for | Primary |
| | | each test taken by the | |
| | | client per visit | |
| ScreeningId | numeric | Unique identifier for | Foreign |
| | | client screening | [ClientScreening] |
| TestId | numeric | Test identifier from list | Foreign |
| | | manager form List Tests | [ListMan].[Items] |

TABLE 24
Test Results.
This table will store the common test
information for tests that a client takes.

| FIELD | DATA | RANGE/ | |
|---|---|---|---|
| NAME | TYPE | VALUE | DESCRIPTION |
| ResultId | numeric | | Unique Identifier for each test |
| | | | results.. Key = Prnmary |
| TestTakenId | numeric | | Unique identifier for each test taken |
| | | | by the client per visit. Key = |
| | | | Foreign [TestTaken] |
| TestAttribid | numeric | | Test attribute identifier from list |
| | | | manager from the List Tests, the test |
| | | | identified by the TestId in the |
| | | | TestTaken table. Key = Foreign |
| | | | [ListMan]. [Items] |
| Result | test | 50 | test result |

Every test has a test duration attribute which is Data Type integer, Data Mask 9#, Units of Measure minutes, as follows:

TABLE 25
Abdominal Aortic Aneurysm. Category: Cardiovacular

| | | UNITS | | |
|---|---|---|---|---|
| | | OF | | |
| ITEM | DATA | MEA- | | |
| NAME | TYPE | SURE | DATA MASK | DESCRIPTION |
| Aneurysm | LimitToList | | Unique | Existence of |
| | | | identifier for | possible |
| | | | category | aneurysm from |
| | | | from list | ListLimitTolist. |
| | | | manager from | YesNo. |
| | | | List Categories | |
| Arctic | Single | cm | 99.9 | Size of aneurysm |
| Diameter | | | | |
| Aoertic | LimitToList | | | Percentage of |
| Plaque | | | | plaque in |
| | | | | abdominal aorta |
| | | | | from |
| | | | | ListLimitToList. |
| | | | | Plaque |
| Aortic | LimitToList | Yes/No | | Whether the client |
| Follow Up | | | | needs follow up |
| | | | | by a doctor from |
| | | | | ListLimitToList. |
| | | | | YesNo. |
| Aortic | Text | | | comments |
| Comments | | | | |

TABLE 26
Ankle Brachial Index.Category: Cardiovascular

| ITEM | | UNITS OF | DATA | |
|---|---|---|---|---|
| NAME | DATA TYPE | MEASURE | MASK | DESCRIPTION |
| Left Ankle | Integer | mm Hg | 99# | Measurement |
| | | | | from left ankle |
| Left | Integer | mm Hg | 99# | Measurement |
| Brachial | | | | from left brachial |
| | | | | (Wrist) |
| Left ABI | Single | | 9.99 | Ankle Brachial |
| | | | | Index from left |
| | | | | side |
| Left result | LimitToList | | | Left side flow |
| | | | | result from |
| | | | | ListLimitToList, |
| | | | | NormalAbnormal |
| Right Ankle | Integer | mm Hg | 99# | Measurement |
| | | | | from right ankle |
| Right | Integer | mm HG | 99# | Measurement |
| Brachial | | | | from right |
| | | | | brachial (wrist) |
| Right ABI | Single | | 9.99 | Ankle Brachial |
| | | | | Index from right |
| | | | | side. |
| Right | LimitToList | | | Right side flow |
| Result | | | | result from List |
| | | | | LimitToList, |
| | | | | NormalAbnormal |

TABLE 27
Arterial Elasticity. Category: Cardiovascular

| | DATA | UNITS OF | DATA | |
|---|---|---|---|---|
| ITEM NAME | TYPE | MEASURE | MASK | DESCRIPTION |
| Systolic | Integer | mm Hg | 99# | Systolic pressure |
| Diastolic | Integer | mm HG | 99# | Diastolic pressure |
| Pulse | Integer | BPM | 99# | Number of heart |
| | | | | beats per minute |
| Pulse Pressure | Integer | mm HG | 99# | difference |
| | | | | between |
| | | | | Systolic ad |
| | | | | Diastolic |
| Pulse Wave | LimitToList | | | Pattern |
| Pattern | | | | demonstrating |
| | | | | elasticity of the |
| | | | | brachial artery |
| | | | | from |
| | | | | List LimitToList, |
| | | | | PulseWavePattern |
| | | | | Type |
| AEI | Integer | | 99# | Measure of the |
| | | | | Arterial Elasticity |
| | | | | Index, elasticity |
| | | | | of the brachial |
| | | | | artery |

TABLE 28
Body Composition Test. Category: Body Composition

| ITEM | DATA | UNITS OF | DATA | |
|---|---|---|---|---|
| NAME | TYPE | MEASURE | MASK | DESCRIPTION |
| Height | Integer | in. | 9## | Height of client |
| | | | | measured in inches |
| Weight | Integer | lbs. | 9## | Weight of client |
| | | | | measured in pounds |
| BMI | Single | ([Weight]/[Height]²) | 99.9 | Body Mass Index |
| | | *703 | | |
| Percent | Integer | % mm HG | 9# | Body fat percentage |
| Body Fat | | | | result |

TABLE 29
Test CA 125.
Category: Metabolic and Biochemical Studies

| | DATA | UNITS OF | DATA | |
|---|---|---|---|---|
| ITEM NAME | TYPE | MEASURE | MASK | DESCRIPTION |
| CA 125 Level | Integer | U/ml | 99# | Measure of Carcinoma |
| | | | | Antigen 125 levels |

TABLE 30
Test: Carotid Artery Scan. Category: Cardiovascular

| | DATA | UNITS OF | DATA | |
|---|---|---|---|---|
| ITEM NAME | TYPE | MEASURE | MASK | DESCRIPTION |
| Right Carotid | LimitToList | | | Percentage of |
| Plaque | | | | plaque in right |
| | | | | carotid artery |
| | | | | from |
| | | | | ListLimitToList, |
| | | | | Plaque |
| Right ICA | Single | cm/sec | 999.99 | Right internal |
| Velocity | | | | carotid artery |
| | | | | velocity |
| Right CCA | Single | cm/sec | 999.99 | Right common |
| Velocity | | | | carotid artery |
| | | | | velocity |
| Right ICA | Single | | 999.99 | Right internal |
| CCA Ratio | | | | carotid artery/ |
| | | | | common carotid |
| | | | | artery ratio |
| Left Carotid | LimitToList | | | Percentage of |
| Plaque | | | | plaque in left |
| | | | | carotid artery |
| | | | | from |
| | | | | ListLimitToList, |
| | | | | Plaque. |
| Left ICA | Single | cm/sec | 999.99 | Left internal |
| Velocity | | | | carotid artery |
| | | | | velocity |
| Left CCA | Single | cm/sec | 999.99 | Left common |
| Velocity | | | | carotid artery |
| | | | | velocity |
| Left ICA | Single | | 999.99 | Left internal |
| CCARatio | | | | carotid artery/ |
| | | | | common carotid |
| | | | | artery ratio |
| Follow up | LimitToList | Yes/No | | Whether the |
| | | | | client needs |
| | | | | follow up by a |
| | | | | doctor from |
| | | | | ListLimitToList. |
| | | | | YesNo. |
| Carotid artery | Text | | | Comment |
| comment | | | | |

TABLE 31
Test CE. Category: Metabolic and Biochemical Studies

| | DATA | UNITS OF | DATA | |
|---|---|---|---|---|
| ITEM NAME | TYPE | MEASURE | MASK | DESCRIPTION |
| CEA Level | Single | ng/mL | 999.9 | Measure of |
| | | | | Carcioembryoic |
| | | | | Antigen levels |

TABLE 32
Test Cholesterol. Category: Cardiovascular

| ITEM | DATA | UNITS OF | DATA | |
|---|---|---|---|---|
| NAME | TYPE | MEASURE | MASK | DESCRIPTION |
| HDL | Ointeger | mg/dL | 99# | level of High-density |
| | | | | liporprotein cholesterol |
| Total | integer | mg/dL | 99# | Measure of total |
| Cholesterol | | | | cholesterol count |
| Cholesterol | Single | | 999.9 | Calculated ratio of |
| HDL Ratio | | | | total to HDL |

TABLE 33
Test CA 125. Category: Metabolic and Biochemical Studies

| | DATA | UNITS OF | DATA | |
|---|---|---|---|---|
| FIELD NAME | TYPE | MEASURE | MASK | DESCRIPTION |
| WBC | Sincle | 10³/ul | 999.9 | White blood cell count |
| RBC | Single | 10⁶/ul | 99.9 | Red blood cell count |
| Hgb | Single | g/dL | 999.9 | Hemoglobin level |
| Hct | Single | % | 999.9 | Hematocrit-% of red |
| | | | | cells in blood |
| MCV | Integer | fL | 999# | Mean corpuscular |
| | | | | volume - size of |
| | | | | average red cell |
| MCH | Single | pg | 999.9 | Mean corpuscular |
| | | | | hemoglobin - weight |
| | | | | of average red cell |
| MCHC | Single | g/dl | 99.9 | Mean corpuscular |
| | | | | hemoglobin concentra- |
| | | | | tion - amount of |
| | | | | hemoglobin in |
| | | | | average red cell |
| Neutrophils | Integer | % | 99# | % of neutrophils |
| Lymphocytes | Integer | % | 99# | % of lymphocytes |
| Monocytes | Integer | % | 99# | % of monocytes |
| Eosinophils | Integer | % | 9# | % of eosoinophils |
| Basophils | Integer | % | 9# | %of basophils |
| Neutrophil | Single | 10³/ul | 99.9 | Neutrophil count |
| Count | | | | |
| Lymphocyte | Single | 10³/ul | 99.9 | Lymphocytes count |
| Count | | | | |
| Monocyte | Single | 10³/ul | 9.9 | Monocyte count |
| Court | | | | |
| Eosinophils | Single | 10³/ul | 9.9 | Eosinophil count |
| Count | | | | |
| Basophil | Single | 10³/ul | 9.9 | Basophil count |
| Count | | | | |
| Platelets | Integer | 10³/ul | 999# | Platelet count |

TABLE 34
Test Complex Metabolic Panel.
Category: Metabolic and Biochemical Studies

| | DATA | UNITS OF | DATA | |
|---|---|---|---|---|
| ITEM NAME | TYPE | MEASURE | MASK | DESCRIPTION |
| BUN | Integer | mg/dL | 99# | blood urea nitrogen |
| Creatinine | Single | mg/dL | 99.9 | Creatinine |
| BUN Creat | Single | mg/dL | 99.9 | BUN/Creatinine Ratio |
| Radio | | | | |
| Uric Acid | Single | mg/dL | 99.9 | Uric Acid |
| Sodium | Integer | mmol/L | 999# | Sodium |
| Potassium | Single | mmol/L | 9.9 | Potassium |
| Chloride | Integer | mmol/L | 999# | Chloride |
| Carbon | Integer | mmol/L | 99# | Carbon Dioside |
| Dioxide | | | | |
| Calcium | Single | mg/dL | 999.9 | Calcium |
| Ionized | Single | mg/dL | 99.9 | Ionized calcium |
| Calcium | | | | |
| Inorg | Single | mg/dL | 99.9 | Inorganic phosphorus |
| Phosphorus | | | | |
| Total Protein | Single | g/dL | 99.9 | Total protein |
| Albumin | Single | g/dL | 99.9 | Albumin |
| Globulin | Single | g/dL | 99.9 | Globulin |
| Albumin | Single | | 99.9 | Albumin/Globulin |
| Globulin Ratio | | | | Ratio |
| Total Bilirubin | Single | mg/dL | 99.9 | Total bilirubin |
| Alk | Integer | U/L | 999# | Alkaline Phosphatase |
| Phosphatase | | | | |
| GGTP | Integer | U/L | 99# | Gamma-Glutamyl |
| | | | | Transferase |
| LDH | Integer | U/L | 999# | Lactic Dehydrogenase |
| SGOT | Integer | U/L | 99# | Serum glutamic oxal- |
| | | | | oacetic transaminase |
| SGPT | Integer | U/L | 99# | serum glutamic- |
| | | | | pyruvic transaminase |
| Serumiron | Integer | ug/dL | 999# | serum iron |
| AST | Integer | U/L | 99# | Aspartate Amino- |
| | | | | transferase |
| Glucose | Integer | mg/dL | 99# | |

TABLE 35
Test Fasting Glucose and Triglycerides -
This test includes the Cholesterol test.
Category: Cardiovascular, Diabetes

| | DATA | UNITS OF | DATA | |
|---|---|---|---|---|
| ITEM NAME | TYPE | MEASURE | MASK | DESCRIPTION |
| LDL | Integer | mg/dL | 99# | Level of low-density |
| | | | | lipoprotein cholesterol |
| Triglycerides | Integer | m/dL | 99# | Measured level of |
| | | | | triglycerides in the |
| | | | | blood |
| Blood Glucose | Integer | m/dL | 99# | Glucose level |
| | | | | measured in |
| | | | | client's blood |

TABLE 36
Test: FSH. Category: Metabolic and Biochemical Studies

| | DATA | UNITS OF | DATA | |
|---|---|---|---|---|
| ITEM NAME | TYPE | MEASURE | MASK | DESCRIPTION |
| FSH Level | Single | MI^{U}/mL | 999.9 | Measure of Follicle |
| | | | | Stimulating Hormone |
| | | | | Levels |

TABLE 37
Test: Homocystein.
Category: Metabolic and Biochemical Studies

| | DATA | UNITS OF | DATA | |
|---|---|---|---|---|
| ITEM NAME | TYPE | MEASURE | MASK | DESCRIPTION |
| Homocysteine | Single | mmol/L | 999.9 | Measure of Homo- |
| Level | | | | cysteine levels |

TABLE 38
Test: Lung Capacity Screening. Category: Lung Capacity.

| | DATA | UNITS OF | DATA | |
|---|---|---|---|---|
| ITEM NAME | TYPE | MEASURE | MASK | DESCRIPTION |
| FEV1 | Single | L | 99.99 | Forced Expired |
| | | | | Volume in 1 |
| | | | | second |
| FEV1 | Integer | % | 99# | Percent of normal |
| Predicted | | | | for FEV1 |
| FVC | Single | L | 99.99 | Force Vital Capacity |
| FVC Predicted | Integer | % | 99# | Percent of normal |
| | | | | for FVC |

TABLE 39
Test: Osteoporosis Screening. Category: Osteoporosis

| ITEM | DATA | UNITS OF | DATA | |
|---|---|---|---|---|
| NAME | TYPE | MEASURE | MASK | DESCRIPTION |
| T Score | Single | SD | $9.9 | Standard deviation of client's |
| | | | | bone density from normal |
| BMD | Single | g/cm² | 0.#99 | Measure of client's Bone |
| | | | | Mass Density |

TABLE 40
Test: Prostate Specific Antigen.
Category: Metabolic and Biochemical Studies

| | DATA | UNITS OF | DATA | |
|---|---|---|---|---|
| ITEM NAME | TYPE | MEASURE | MASK | DESCRIPTION |
| PSA Level | Single | ng/mL | 999.99 | Measure of prostate- |
| | | | | specific antigen levels |

TABLE 41
Test: Thyroid Panel.
Category: Metabolic and Biochemical Studies

| | DATA | UNITS OF | DATA | |
|---|---|---|---|---|
| ITEM NAME | TYPE | MEASURE | MASK | DESCRIPTION |
| TSH | Single | mlU/L | 99.9 | Thyroid stimulating |
| | | | | hormone level |
| T3 | Integer | ng/dL | 99# | triiodthyronine |
| T4 | Single | ug/dL | 999.9 | Thyroxine |
| T7 | Single | U | 99.9 | Free thyroxine |
| | | | | index |

TABLE 42
Test: Thyroid Panel Scan. Category: Thyroid

| | DATA | UNITS OF | DATA | |
|---|---|---|---|---|
| ITEM NAME | TYPE | MEASURE | MASK | DESCRIPTION |
| Thyroid Scan | LimitToList | | | Result from scan |
| Result | | | | of thyroid from |
| | | | | List LimitToList. |
| | | | | NormalAbnormal |
| Thyroid Scan | Text | | | comment |
| Comment | | | | |

Look up tables and lists from List Manager are used as follows:

TABLE 43
Country

Afghanistan
Albania
—
—
Yugoslavia
Zaire
Zambia
Zimbabwe

TABLE 44
HeardAboutUs

Newspaper
Radio
Billboard
Television
Workplace
Internet
Relative
Friend
Physician/Healthcard Professional
Church/Community Center
Public Event

TABLE 45
Race

Asian
Black
Caucasian
Hispanic
Other

TABLE 46
SpecialNeeds

Hearing Impaired
Language Barrier
Walking Aid
Wheelchair
Vision Impaired
Other

TABLE 47

| State | |
|---|---|
| Abbreviation | State |
| Al | Alabama |
| AK | Alaska |
| — | |
| WY | Wyoming |
| Yukon | Yukon |

TABLE 48
List Appointment Type

Item Name
Scheduled
Walk-in

TABLE 49
NormalAbnormal

Normal
Abnormal
Walk-in

TABLE 50
Plaque

None/Minimal
Mild
Moderate
Severe

TABLE 51
PulseWavePatternType

A
B
C
D
E
AB
ABC
ABCD
ABD
AC
ACD
AD
BC
BCD
BCDE
BD
BDE
BE
CD
CDE
CE
DE

TABLE 52
Race

Asian
Black
Caucasian
Hispanic
Other

TABLE 52
Race

Asian
Black
Caucasian
Hispanic
Other

The following is an example of the table used for process flows. This process provides a mechanism to collect and maintain client information and test results to generate personal and organizational wellness reports.

TABLE 54
Key-Event list

| Event | Trigger (inputs) | Action (outputs) |
|---|---|---|
| Client requests to be tested | Motivated by ad- | Add/update client |
| or change demographic info | vertising scheme | Add/update organization |
| Organization requests a | Motivated by ad- | Add/update organization |
| new group event | vertising scheme | Add/update group event |
| or a change to an | or contractual | Add/update location |
| existing event | agreement | |
| Organization requires | Change in organi- | Update organization |
| demographic change | zation inform- | |
| | ation | |
| Organization cancels event | Motivation by or- | Delete group event |
| | ganization decis- | Delete location (if no |
| | ion | dependencies) |
| Client completes test(s) or | Test initiated | Add screening event if |
| test results are received | | needed |
| from a previously taken test | | Add tests result |
| Time to generate personal | Individual testing | Generate personal report |
| report | completed | |
| Time to generate group | Group testing | Generate group report |
| report | completed | |
| HSA opens new store | Company growth | Add location |
| HSA adds/changes | Change in test | Add/Update test type |
| descriptive test info | type name, de- | Add/Update category |
| | scription, or | |
| | category | |

II. Process Uses with Individual Consumers and Organizations

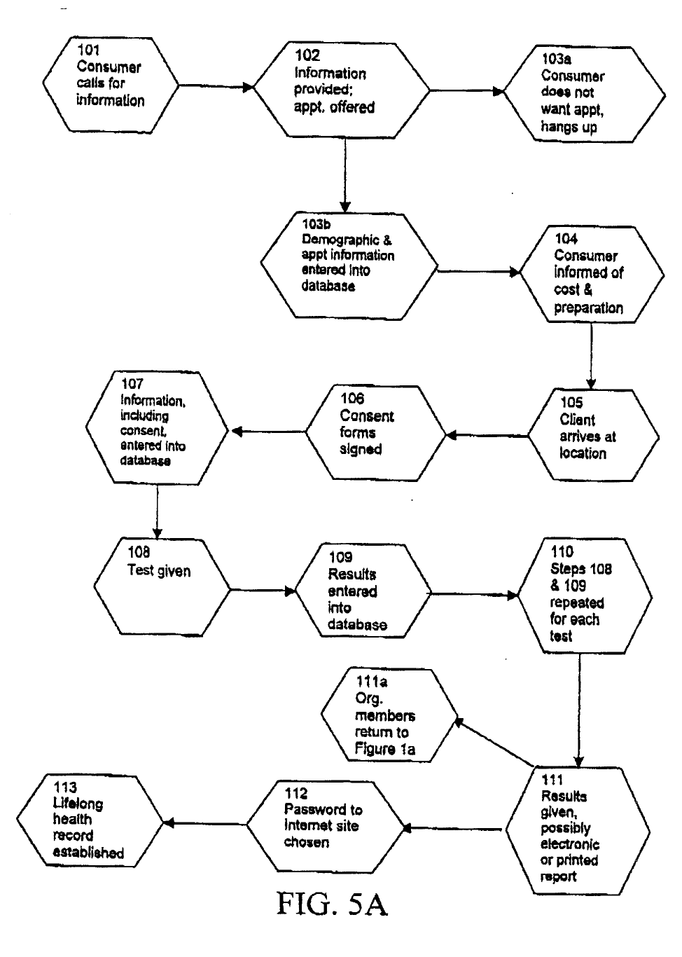

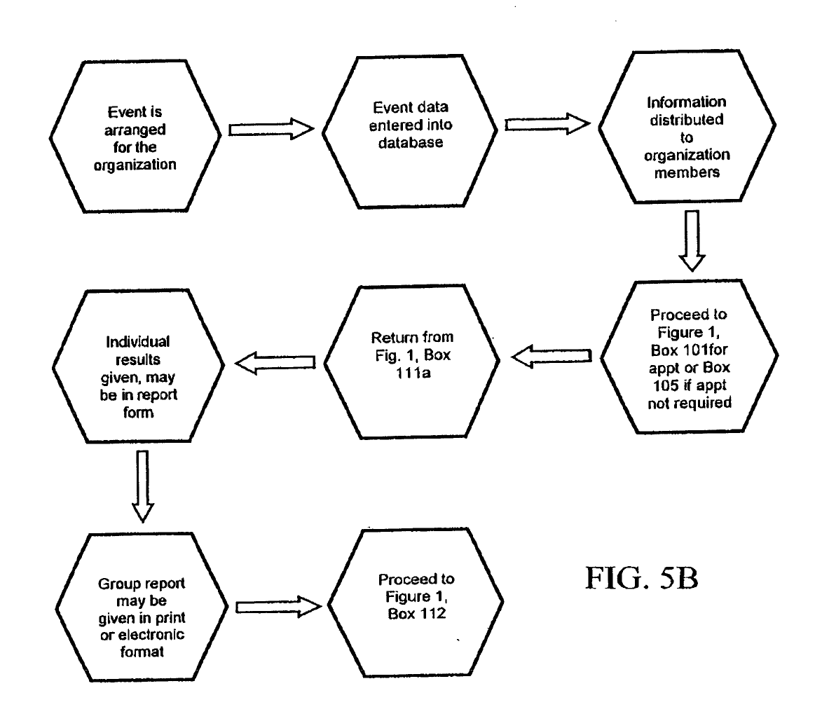

FIG. 5A is a flowchart showing the process for the individual with sub chart, FIG. 5B, showing the process when an organization is sponsoring or hosting the health-screening event.

Individual consumers call to obtain information and make an appointment. The individual's demographic data is entered into the database along with the time, date and location of appointment and the tests or test package desired. The cost is automatically figured and the appointment maker goes over the cost and any preparation needed, such as four hours of fasting for the glucose test.

FIG. 5B starts with the booking of the event for the organization. All pertinent information is entered into the database, including time, date, location, tests or packages offered. Organizations can choose one package for each member or employee at a discounted fee or may choose to let their members or employees choose the tests desired. Responsibility for payment is also noted in the database as some business organizations fully cover the costs of the program for their employees under wellness plans. Health screenings can also be booked as events when a public organization, such as a local school or health department, wants to hold open house health fairs. Generally, no advance appointments are needed. Types of tests given at health fairs may be limited to basics such as blood pressure, cholesterol readings, and vision/hearing screenings. Often, cost is nominal or free. In those cases, the event is entered into the database, so that data can be entered and tracked on the day of the event.

Upon arrival at the location, both individuals and members of organizations are asked to sign consent forms. The consent forms consist of four sections:

(1) consent to take the tests;

(2) consent to have the results posted on a secured, privacy-protected “life long health record” accessible electronically;

(3) consent to receive information in electronic and/or printed formats;

(4) consent to let their data be anonymously used in a statistical database to help forecast health trends and assess risk factors among a largely a-symptomatic population and to be informed of clinical trials and experimental treatments that may pertain to them, according to their test results.

In the preferred embodiment, all four consents would be given, but clients are given the tests as long as they sign the first portion of the consent form. Information including which consents were given and the date signed is entered into the database prior to any tests being performed. As a safeguard, the program is designed to prevent any further action being taken until the consent information is entered. At the point the consent information is entered, the computer automatically assigns a 14 digit unique identifier to the client. The use of this identifier increases security. Many consumers are concerned that insurance carriers or employers may use information about health risks to deny coverage or employment opportunities. Avoiding the use of easily traceable numbers, such as social security numbers, helps maintain the consumer's right to privacy. Each time a client comes in, the consent forms are reviewed, and any changes are noted.

The client is taken to the testing area where the procedure is explained in detail by the technician. The test is performed and the data is entered into the database in the most error-free way possible. In the preferred embodiment, the data is not entered by data entry personnel but by direct entry from the equipment or a smart card-type device. To further increase accuracy, additional accuracy checks may be instituted on a regular basis. For instance, another member of the facility staff not involved with the consumer's screening test may review the test results to certify that the results were entered correctly. In the preferred embodiment, two additional accuracy checks are routinely made to ensure the data is correct to the greatest degree possible. Such direct entry avoids the risk of human error, such as reversing digits, and ensures a higher degree of accuracy.

Typical screening tests include, but are not limited to, ankle brachial index, abdominal aortic aneurysm, carotid ultrasound scan, thyroid ultrasound scan, osteoporosis screening, body composition, blood and pulse pressure, oxygen saturation, hearing screening, vision screening, urine analysis, , blood studies (PSA, blood count, chemistry panel, lipid panel, triglycerides and risk ratio, thyroid blood test, C-reactive protein, fibrogen, homocysteine, CEA, CA-125), hormones, CT scans.

Once all tests are completed, the client may be given a report. The printed report preferably includes results from the screening with analysis and related information as well as a summary for the physician. Suggestions may be included from acknowledged experts in the field (American Diabetes Association). For example, the suggestion to eat a low fat diet and increase exercise could be made to a client with high body fat content and high cholesterol levels. In a preferred embodiment, only suggestions and recommendations widely accepts by the medical community and supported by well-respected authorities in the filed, such as the American Diabeted Association, are made to consumers. However, under circumstances in which the invention was being practiced by the consumer's personal physician, the preferred embodiment could include additional recommendations. The only test results that could not be included on the immediate report are those requiring medical review, such as the CT lung scan which needs to be reviewed by a radiologist. The client may be informed those results will be sent within a few days.

For events hosted by organizations, an additional report may be generated which employers use to design effective wellness programs for their employees. Reports are discussed in greater detail in Section III, and examples are included.

Part or all of the data can also be sent electronically and maintained on a web server for confidential access with typical browsers. The health and demographic data collected from the screening can pre-populate a life-long health record.

The data may also be viewed by other well-known techniques such as email, interactive television, and the like. The computer site is preferably viewed with a client web browser as an HTML document through a web secure server communicating with an application server having a database therewith. In the preferred embodiment, the client is assigned a password to use on the Internet web site which stores the test results, downloaded directly from the database. This allows immediate, secured access to the records by the consumer and appropriate physician. Additional reports can be printed and information can be updated to include other health records; however, no changes can be made to the test results. Other educational information can also be found on the web site and links are provided to additional helpful sites. Each time a client returns for additional testing, the database and lifelong health record on the web site are automatically updated through the database.

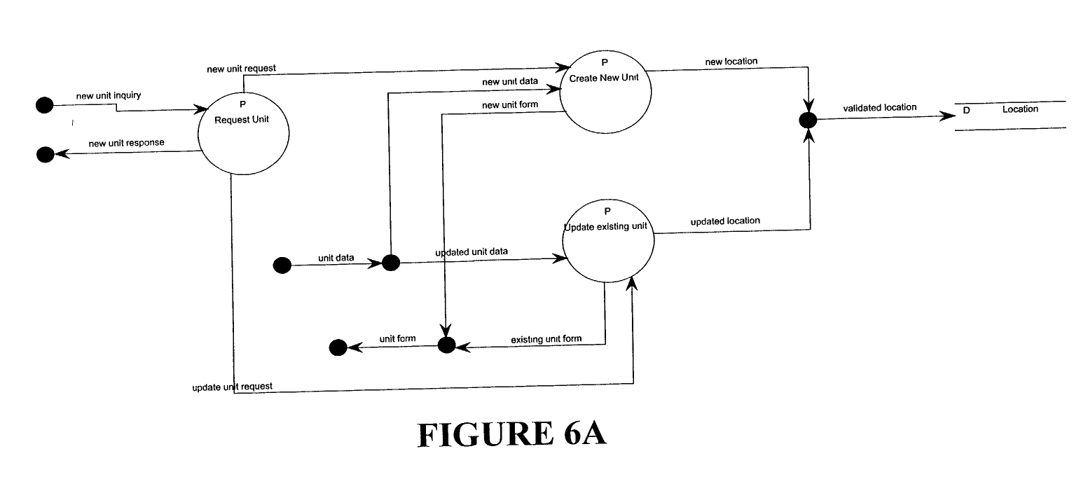

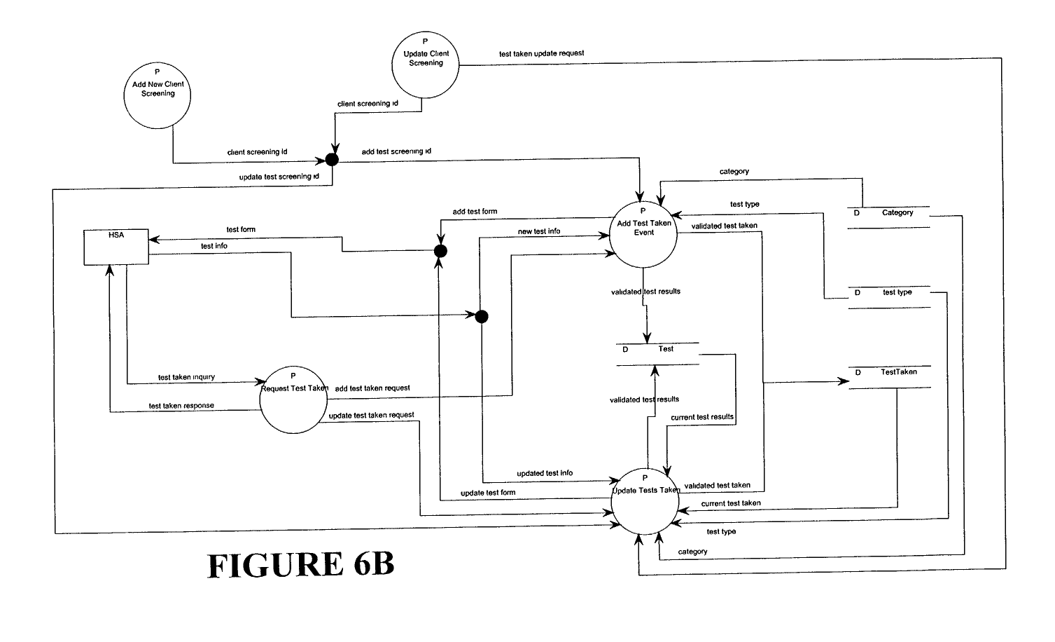

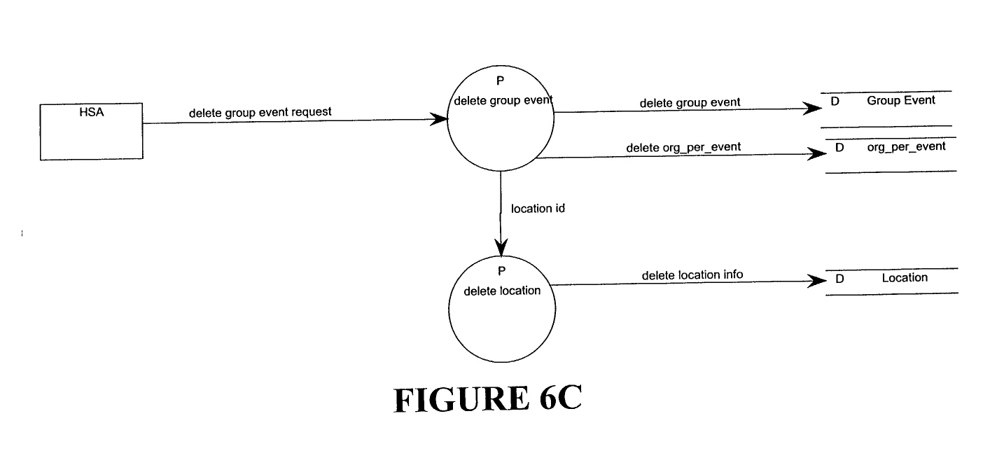

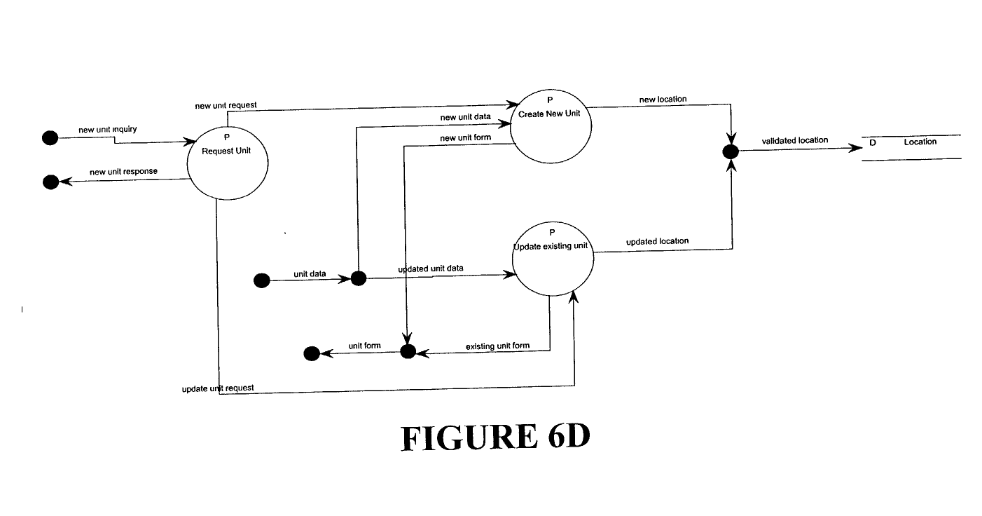

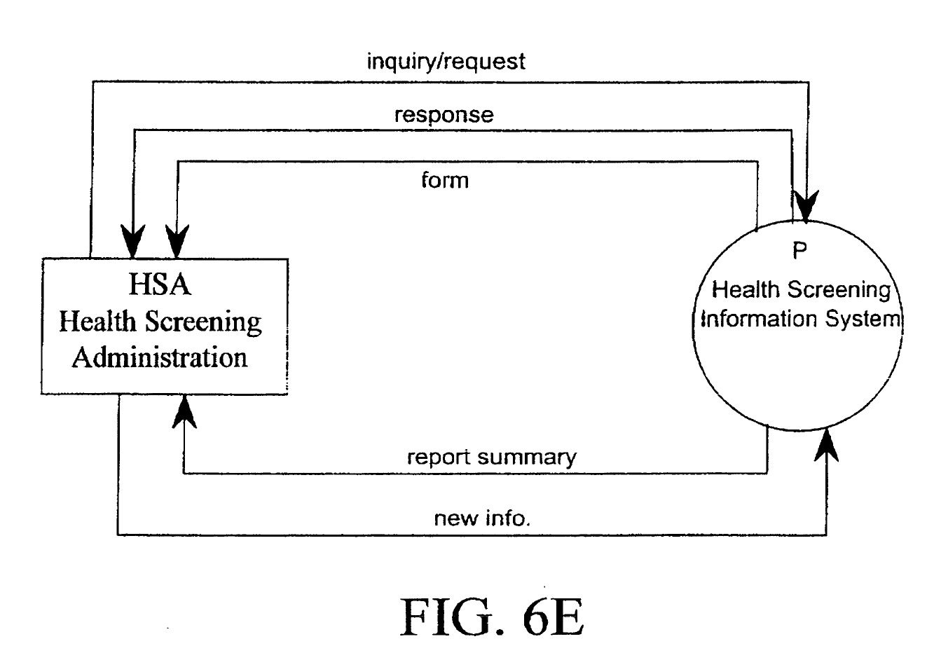

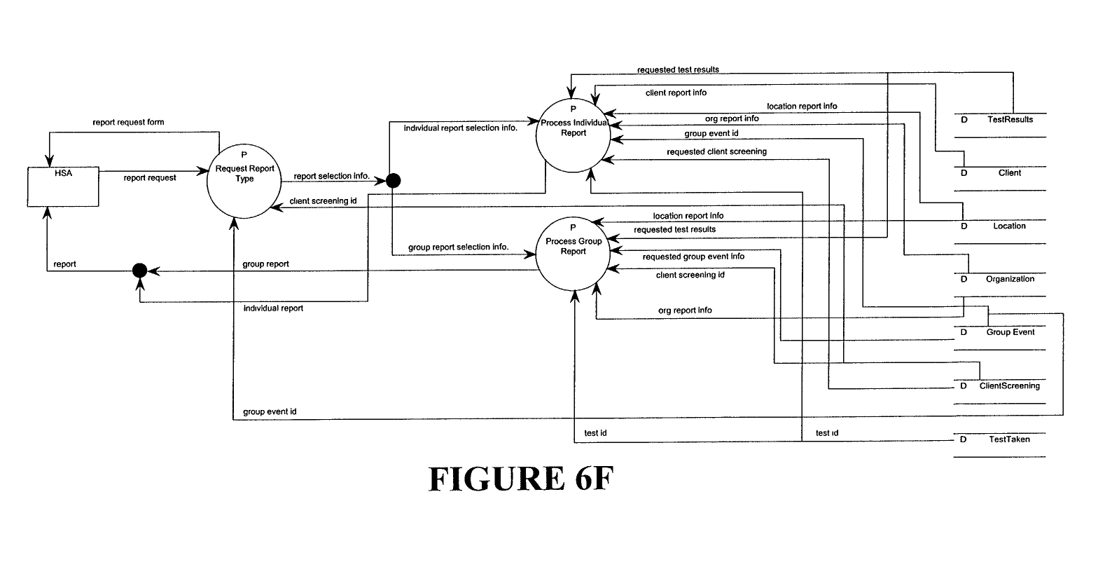

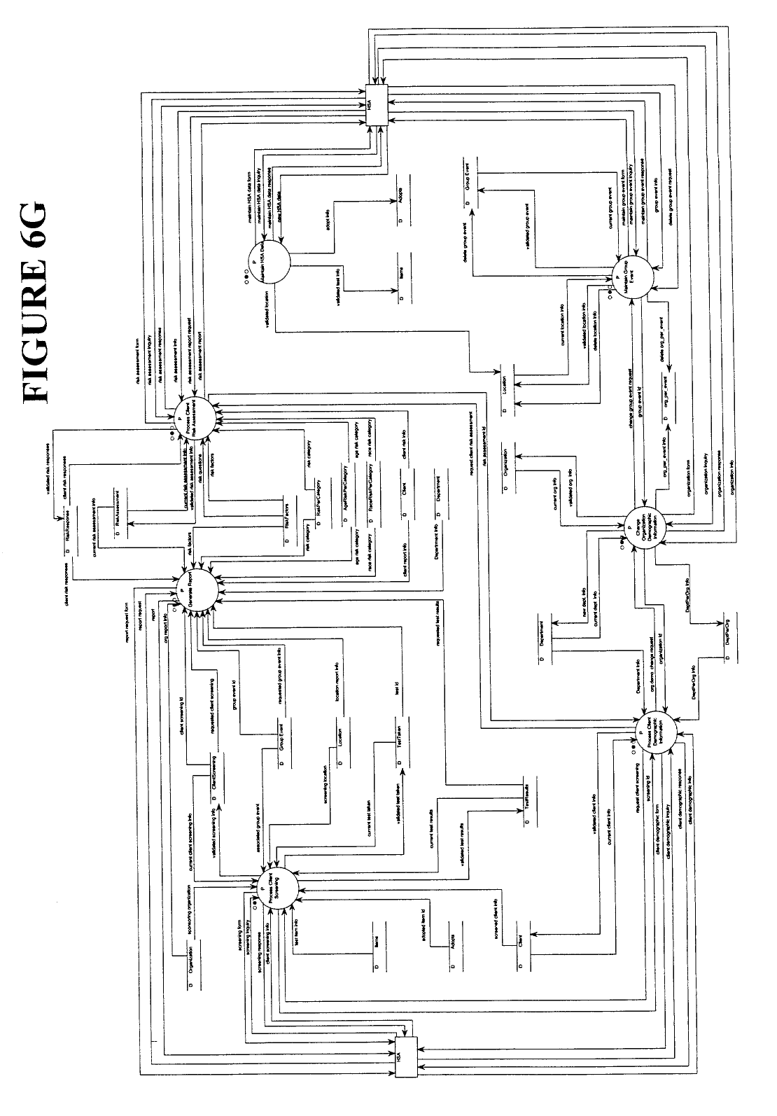

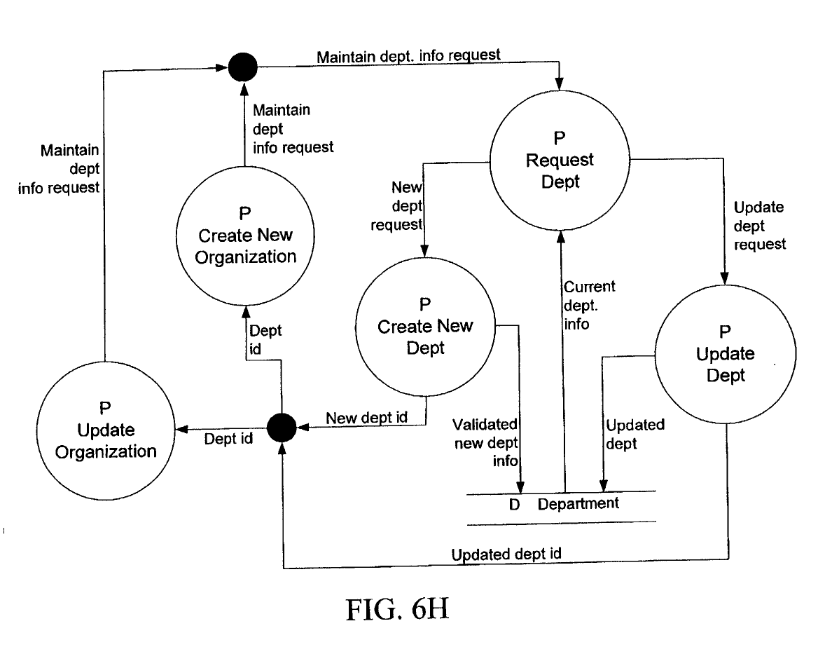

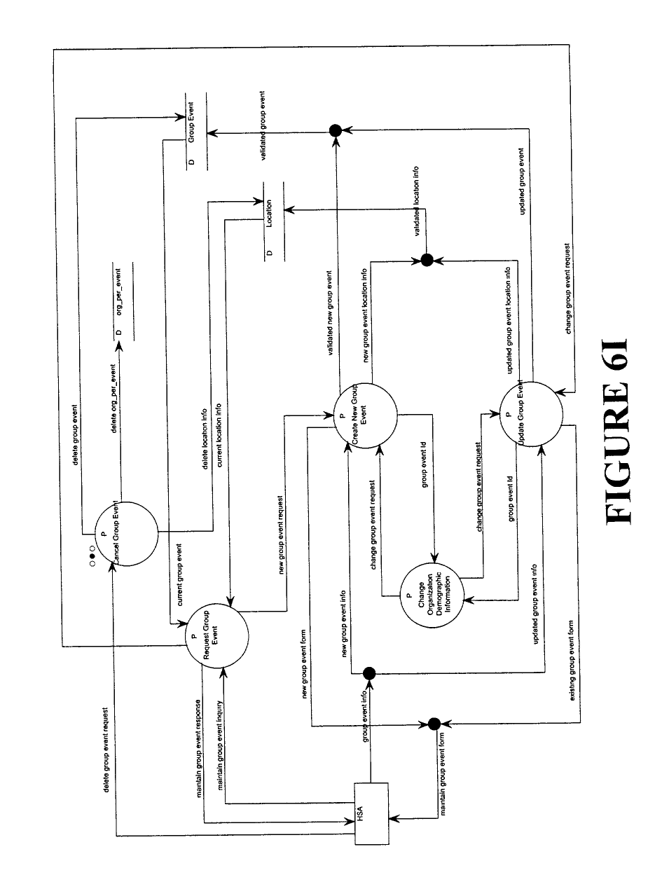

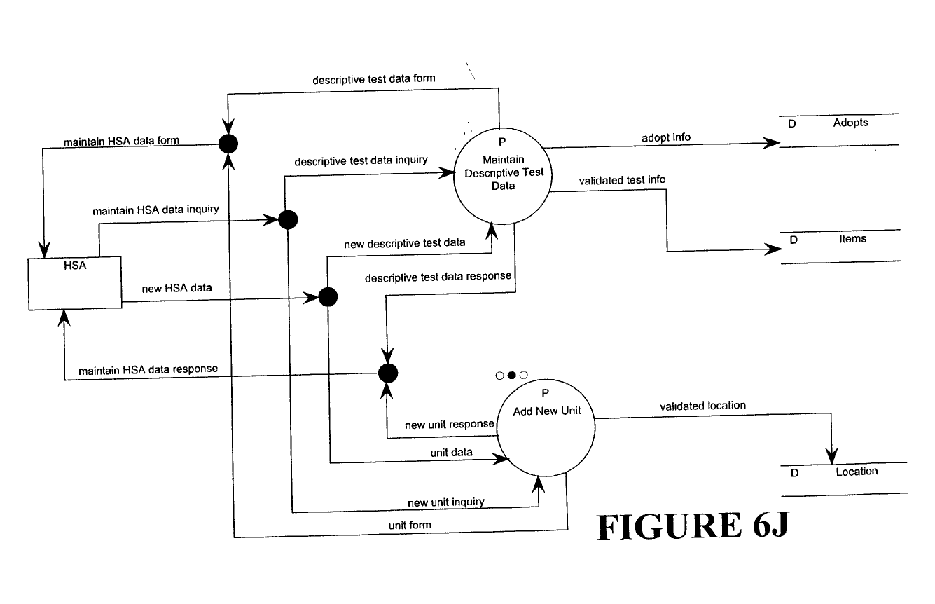

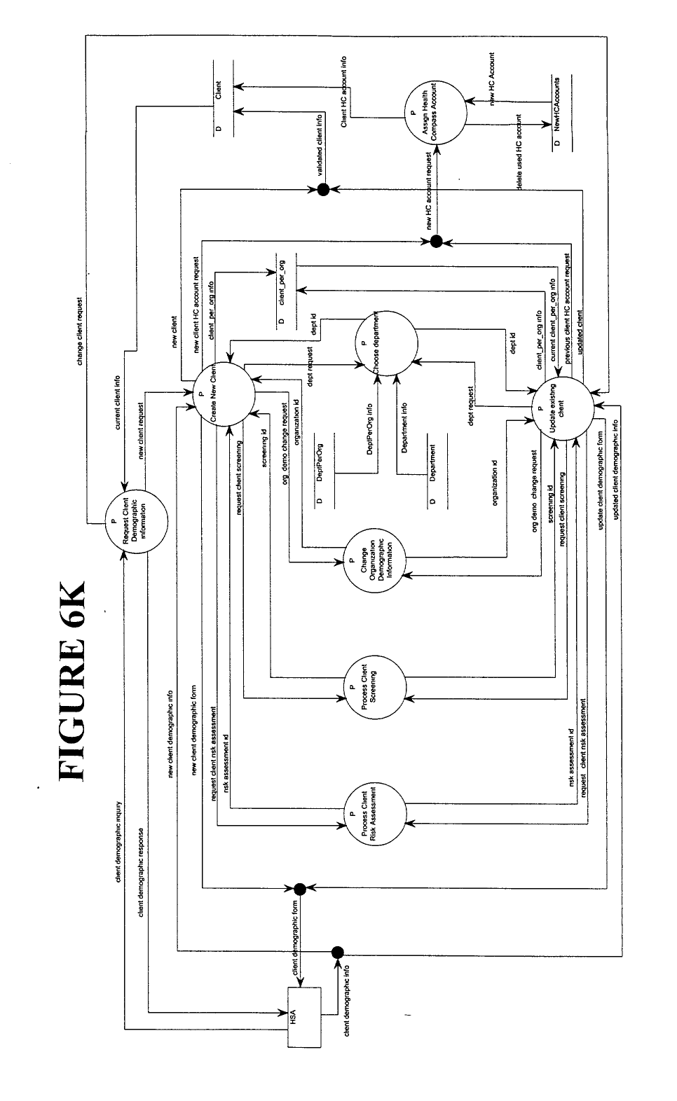

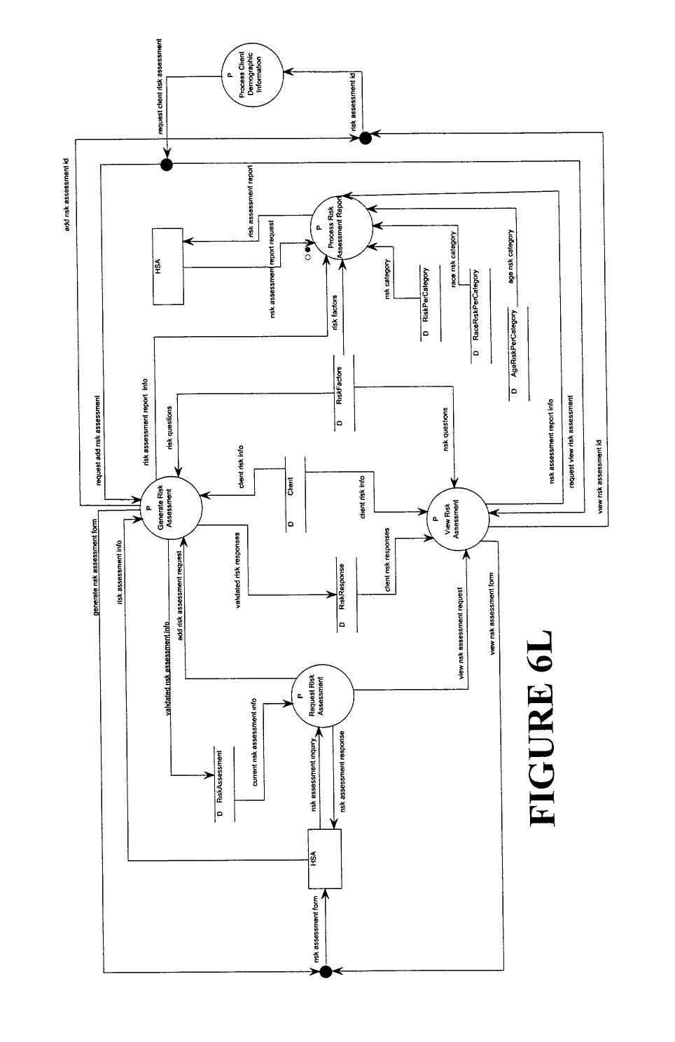

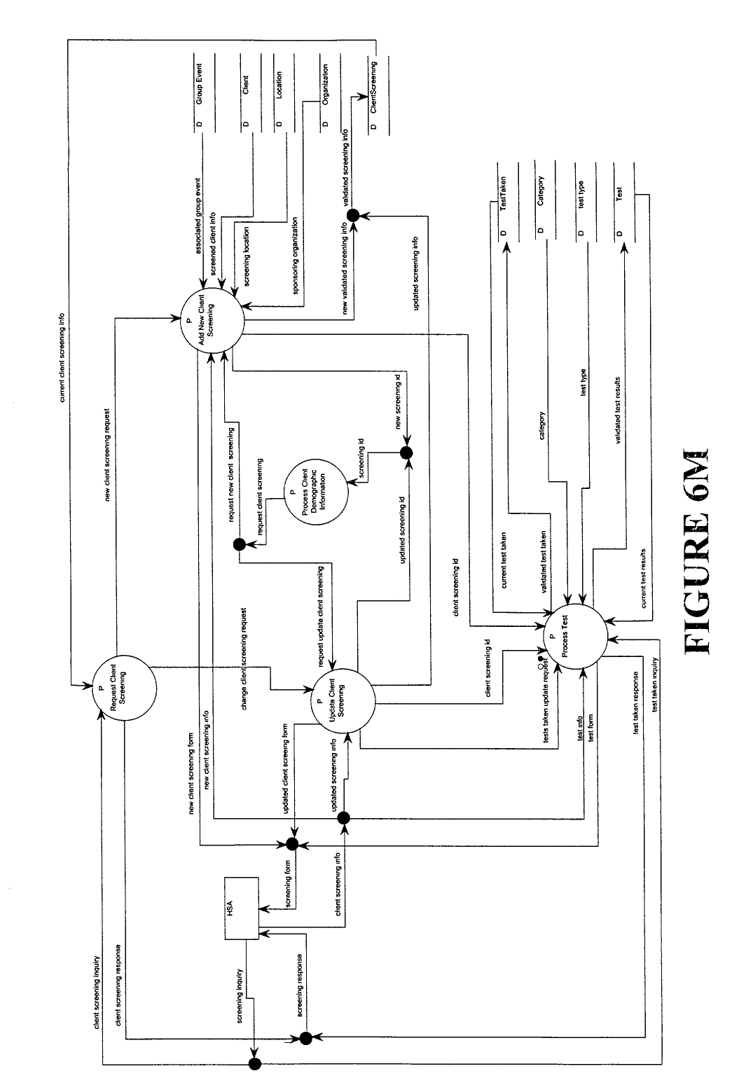

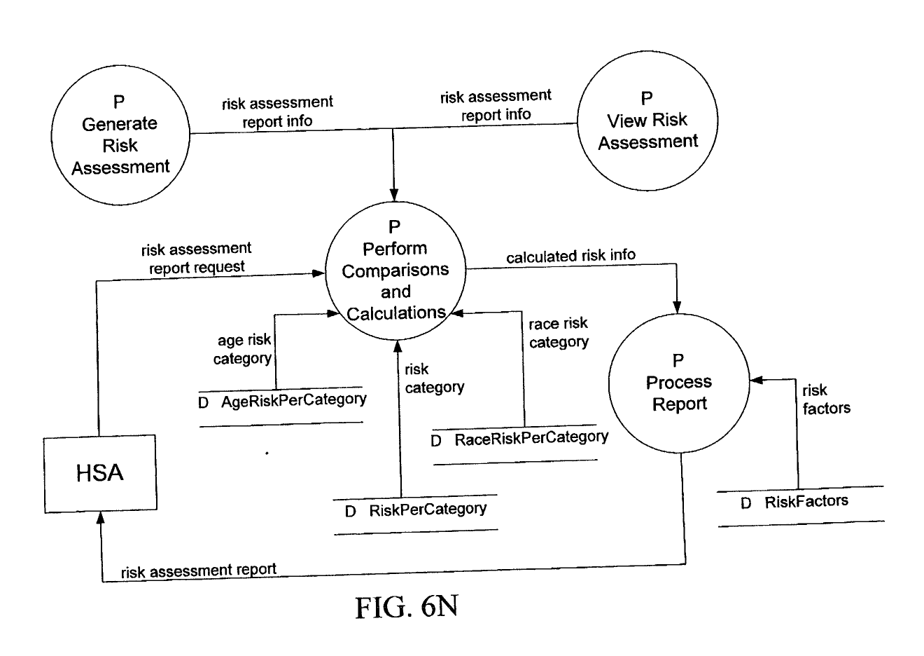

The following description with reference to flowcharts in FIGS. 6A-6F describe in more detail the process and dataflow of the preferred embodiment, including adding a new unit (FIG. 6A), adding a test (FIG. 6B), canceling a group event (FIG. 6C), changing organization demographic information (FIG. 6D), context (FIG. 6E), generating reports (FIG. 6F), Level 1 (FIG. 6G), maintaining department information (FIG. 6H), maintaining group events (FIG. 6I), maintaining system data (FIG. 6J), processing client demographic information (FIG. 6K), processing client risk assessment (FIG. 6L), processing client screening (FIG. 6M), and processing risk assessment reports (FIG. 6N).

Turning now to FIG. 6A, the processes and data flow for adding a new unit is shown. The processes include creating a new unit (input flows: new unit data and new unit request; output flows: new location and new unit form), requesting unit (input flows: new unit inquiry; output flows: new unit request, new unit response, and update unit request) and updating an existing unit (input flows: update unit request and updated unit data; output flows: existing unit form and updated location). The Datastore includes: Location (input flow: validated location coming from new location or updated location).

FIG. 6B shows the processes and data flow for adding a test. The processes include add new client screening (input flows: none; output flows: client screening id), adding test taken event which adds test results to client's screening (input flows: add test screening id, add test taken request, adopted item id, new test information, and test item information; output flows: add test form, validated test results, and validated test taken), requesting test taken (input flows: test taken inquiry; output flows: add test taken request, test taken response, update test taken request), updating client screening (input flows: none; output flows: client screening id, test taken update request), and updating tests taken which finds a test taken by the client screening id and the test taken id and updates any prior test results on the test results form in edit mode (input flows: adopted item id, current test results, current test taken, test item information, test taken update request, update test screening id, update test taken request, updated test information; output flows: update test form, validated test results, validated test taken). The Datastore includes: Adopts (output flows: adopted item id going to Add Test Taken Event and going to Update Tests Taken), Items (output flows: test item info going to Add Test Taken Event and going to Update Tests Taken), TestResults (input flows: validated test results coming from Add Test Taken Event and from Update Tests Taken; output flows: current test results going to Update Tests Taken), Test Taken (input flows: validated test taken coming from Add Test Taken Event and from Update Tests Taken; output flows: current test taken going to Update Tests Taken).

FIG. 6C shows the processes and data flow for canceling a group event. The processes include: delete group event which deletes a group event wherein if Group Event has relationship then display error message else delete Group Event from tables: Group Event and OrgPerEvent (input flows: delete group event; output flows: delete group event, delete org_per_event, location id), and delete location which finds location information in location data store using location ID such that if location has no dependent data, the location is deleted (input flows: location id; output flows: delete location info). The Datastore include: Group Event (input flows: delete group event coming from delete group event process), Location (input flows: delete location info coming from delete location process), and org_per_event (input flows: delete org_per_event coming from delete group event process).

FIG. 6D shows the processes and data flow for changing organization demographic information. The processes include: Create New Organization (input flows: dept id, group event id, new organization info, new organization request; output flows: DeptPerOrg Info, change group event request, maintain dept info request, new organization form, org_per_event info, organization id, validated new organization), Maintain Department Information (input flows: current dept info, maintain dept info request; output flows: dept id, new dept info), Maintain Group Event (input flows: change group event request, organization id; output flows: group event id), Process Client Demographic Information (input flows: organization id; output flows: org. demo. change request), Request Organization finds an organization using Organization Name by the following steps: display organization matches, if organization does not exist, display message “organization does not exist. Do you want to add?”; if user wants to add new organization, request organization form in add mode, else if user does not want to add new organization return to request organization; else is organization exists, display organization information in organization form in edit mode (input flows: current org info, org demo change request, organization inquiry; output flows: new organization request, organization response, update organization request), and Update Organization (input flows: dept id, group event id, update organization request, update organization info; output flows: DeptPerOrg Info, change group event request, existing organization form, maintain dept info request, org_per_event info, organization id, updated organization). The Datastore includes: Department (input flows: new dept info, output flows: current dept info), DeptPerOrg (input flows: DeptPerOrg Info), Organization (input flows: validated org info; output flows: current org info), and org_per_event (input flows: org_per_event info.

FIG. 6E shows the processes and data flow for context. The process includes: Health Screening Information System (input flows: inquiry/request and new info coming from external Health Screening Administration (HSA); output flows: form, report summary, response going to HSA).

FIG. 6F shows the processes and data flow for generating reports. The processes include: Process Group Report (input flows: client screening id, group report selection info, location report info, org report info, requested group event info, requested test results, test id; output flows: group report), Process Individual Report processes reports by individual client screening by retrieving client screening id, client report info, and test results for creation of report (input flows: client report info, group event id, individual report selection info, location report info, org report info, requested client screening, requested test results, test id; output flows: individual report), and Request Report Type operates such that if report type is for individual screening, select client screening by SSN, date, or End Time is NULL, else select group event id by Organization or other criteria to be determined (input flows: client screening id, group event id, report request; output flows: report request form, report selection info). The Datastore include: Client (output flows: client report info), Client Screening (output flows: client screening id, requested client screening), Group Event (output flows: group event id, requested group event info), Location (output flows: location report info), Organization (output flows: org report info), Test Results (output flows: requested test results), and Test Taken (output flows: test id).

FIG. 6G shows the processes and data flow for Level 1. The processes include: Change Organization Demographic Information (input flows: current dept info, current org info, group event id, org demo change request, organization info, organization inquiry; output flows: DeptPerPrg Info, change group event request, new dept info, org_per_event info, organization form, organization id, organization response, validated org info), Generate Report (input flows: department info, age risk category, client report info, client risk responses, client screening id, current risk assessment info, group event id, location report info, org report info, race risk category, report request, requested client screening, requested group event info, requested test results, risk category, risk factors, test id; output flows: report going to HSA and report request form going to HSA), Maintain Group Event (input flows: change group event request, current group event, current location info, delete group event request, group event info, maintain group event inquiry; output flows: delete group event, delete location info, delete org_per_event, group event id, maintain group event form, maintain group event response, validated group event, validated location info), Maintain HSA Data (input flows: maintain HSA data inquiry, new HSA data; output flows: adopt info, maintain HSA data form, maintain HSA data response, validated location, validated test info), Process Client Demographic Information (input flows: department info, DeptPerOrg info, client demographic info, client demographic inquiry, current client info, organization id, risk assessment id, screening id; output flows: client demographic form, client demographic response, org demo change request, request client risk assessment, request client screening, validated client info), Process Client Risk Assessment (input flows: age risk category, client risk info, client risk responses, current risk assessment info, race risk category, request client risk assessment, risk assessment info, risk assessment inquiry, risk assessment report request, risk category, risk factors, risk questions; output flows: risk assessment form, risk assessment id, risk assessment report, risk assessment response, validated risk assessment info, validated risk responses), and Process Client Screening (input flows: adopted item id, associated group event, client screening info, current client screening info, current test results, current test taken, request client screening, screened client info, screening inquiry, screening location, sponsoring organization, test item info; output flows: screening form, screening id, screening response, validated screening info, validated test results, validated test taken).

In FIG. 6G, the Datastore include: Adopts, AgeRiskPerCategory, Client, Client Screening, Department, DeptPerOrg, Group Event, Items, Location, Organization, RaceRiskPerCategory, RiskAssessment, Risk Factors, RiskPerCategory, Risk Response, Test Results, Test Taken, and org_per_event.

FIG. 6H shows the processes and data flow for maintaining department information. The processes include: Create New Department (input flows: new dept info; output flows: new dept id, validated new dept info), Create New Organization (input flows: dept id; output flows: maintain department info request), Request Department (input flows: current dept info, maintain dept info request; output flows: new dept request, update dept request), Update Dept (input flows: update dept request; output flows: updated dept id, updated dept), and Update Organization (input flows: dept id; output flows: maintain dept info request). The Datastore includes: Department (input flows: updated dept, validated new department info; output flows: current dept info).

FIG. 61 shows the processes and data flow for Maintaining Group Events. The processes include: Cancel Group Event which allows finding event ids and selecting event id for deletion (input flows: delete group event request; output flows: delete group event, delete location info, delete org_per_event), Change Organization Demographic Information (input flows: group event id; output flows: change group event request), Create New Group Event (input flows: change group event request, new group event info, new group event request; output flows: group event id, new group event form, new group event location info, validated new group event), Request Group Event finds a group event by Organization or other criteria to be determined, displays group event matches; if a group event does not exist, display message, if user wants to add new group event, request group event form in add mode, else if user does not want to add new group event, return to request group event, else if group event exists, display group event information in group event form in edit mode (input flows: current group event, current location info, maintain group event inquiry; output flows: change group event request, maintain group event response, new group event request), and Update Group Event (input flows: change group event request, updated group event info; output flows: existing group event form, group event id, updated group event, updated group event location info). The Datastore includes: Group Event (input flows: delete group event, validated group event; output flows: current group event), Location (input flows: delete location info, validated location info; output flows: current location info) and org_per_event (input flows: delete org_per_event).

FIG. 6J shows the processes and data flow for Maintaining HSA Data. The processes include: Add New Unit (input flows: new unit inquiry, unit data; output flows: new unit response, unit form, validated location), and Maintain Descriptive Test Data (input flows: descriptive test data inquiry, new descriptive test data; output flows: adopt info, descriptive test data form, descriptive test data response, validated test data). The Datastore include: Adopts (adopt info), Items (validated test info), and Location (validated location).

FIG. 6K shows the processes and data flow for Processing Client Demographic Information. The processes include: Assign Health Compass Account (input flows: new HC account, new HC account request; output flows: client HC account info, delete used HC account), Change Organization Demographic Information (input flows: org demo change request; output flows: organization id), Choose Department (input flows: department info, DeptPerOrg info, dept request; output flows: dept id), Create New Client (input flows: dept id, new client demographic info, new client request organization id, risk assessment id, screening id; output flows: client_per_org info, dept request, new client, new client HC account request, new client demographic form, org demo change request, request client risk assessment, request client screening), Process Client RiskAssessment (input flows: request client risk assessment; output flows: risk assessment id), Process Client Screening (input flows: request client screening; output flows: screening id), Request Client Demographic Information finds a client using SSN wherein if SSN does not exist, display message, if user wants to add new client, request client form in add mode, else if user does not want to add new client, return to request client, else if SSN exists, display client information in client form in edit mode (input flows: client demographic inquiry, current client info; output flows: change client request, client demographic response, new client request), and Update Existing Client (input flows: change client request, current client_per_org info, dept id, organization id, risk assessment id, screening id updated client demographic info; output flows: client_per_org info, dept request, org demo change request, previous client HC account request, request client risk assessment, request client screening, update client demographic form, updated client).

The Datastore in FIG. 6k include: Client (client HC account info, validated client info, current client info), Department (department info), Dept Per Org (DeptPerOrg info), New HC Accounts (delete used HC account, new HC account), and client_per_org (client_per_org info, current client per org info).

FIG. 6L shows the processes and data flow for Processing Client Risk Assessment. The processes include: Generate Risk Assessment (input flows: add risk assessment request, client risk info, request add risk assessment, risk assessment info, risk questions; output flows: add risk assessment id, generate risk assessment form, risk assessment report info, validated risk assessment info, validated risk responses), Process Client Demographic Information (input flows: risk assessment id; output flows: request client risk assessment), Processing Risk Assessment Report (input flows: age risk category, race risk category, risk assessment report info, risk assessment report request, risk category, risk factors; output flows: risk assessment report), Requesting Risk Assessment (input flows: current risk assessment info, risk assessment inquiry; output flows: add risk assessment request, risk assessment response, view risk assessment request), and View Risk Assessment (input flows: client risk info, client risk responses, request view risk assessment, risk questions, view risk assessment request; output flows: risk assessment report info, view risk assessment form, view risk assessment id).

The Datastore in FIG. 6L include: Age Risk Per Category (output: age risk category), Client (output: client risk info), Race Risk Per Category (output: race risk category), Risk Assessment (input: validated risk assessment info, output: current risk assessment info), Risk Factors (output: risk factors, risk questions), Risk Per Category (output: risk category), Risk Response (input: validated risk response; output client risk responses).

FIG. 6M shows the processes and data flow for Processing Client Screening. The processes include: Add New Client Screening (input flows: associated group event, new client screening info, new client screening request, request new client screening, screened client info, screening location, sponsoring organization; output flows: client screening id, new client screening form, new client screening id, new validated screening info), Process Client Demographic Information (input flows: screening id; output flows: request client screening), Process Test (input flows: adopted item id, client screening id, current test results, current test taken, test info, test item info, test taken inquiry, tests taken update request; output flows: test form, test taken response, validated test results, validated test taken), Request Client Screening finds a client screening by SSN, date or end time is NULL (input flows: client screening inquiry, current client screening info; output flows: change client screening request, client screening response, new client screening request), and Update Client Screening (input flows: change client screening request, request update client screening, updated screening info; output flows: client screening id, tests taken update request, updated client screening form, updated screening id, updated screening info).

The Datastore in FIG. 6M include: Adopts (output: adopted item id), Client (output: screened client info), Client Screening (input: validated screening info; output: current client screening info), group Event (output: associated group event), Items (output: test item info), Location (output: screening location), organization (output: sponsoring organization), Test Results (input: validated test results; output: current test results), Test Taken (input: validated test taken; output: current test taken).

FIG. 6N shows the processes and data flow for Processing Risk Assessment Reports. The processes include: Generate Risk Assessment (input flows: none; output flows: risk assessment report info), Perform Comparisons and Calculations (input flows: age risk category, race risk category, risk assessment report info, risk assessment report request, risk category; output flows: calculated risk info), Process Report (input flows: calculated risk info, risk factors; output flows: risk assessment report), and View Risk Assessment (input flows: none; output flows: risk assessment report info). The Datastore include: Age Risk Per Category (output: age risk category), Race Risk Per Category (output: race risk category), Risk Factors (output: risk factors), Risk Per Category (output: risk category).

III. Storage of the Demographic and Screening Information for Analysis and Report Generation

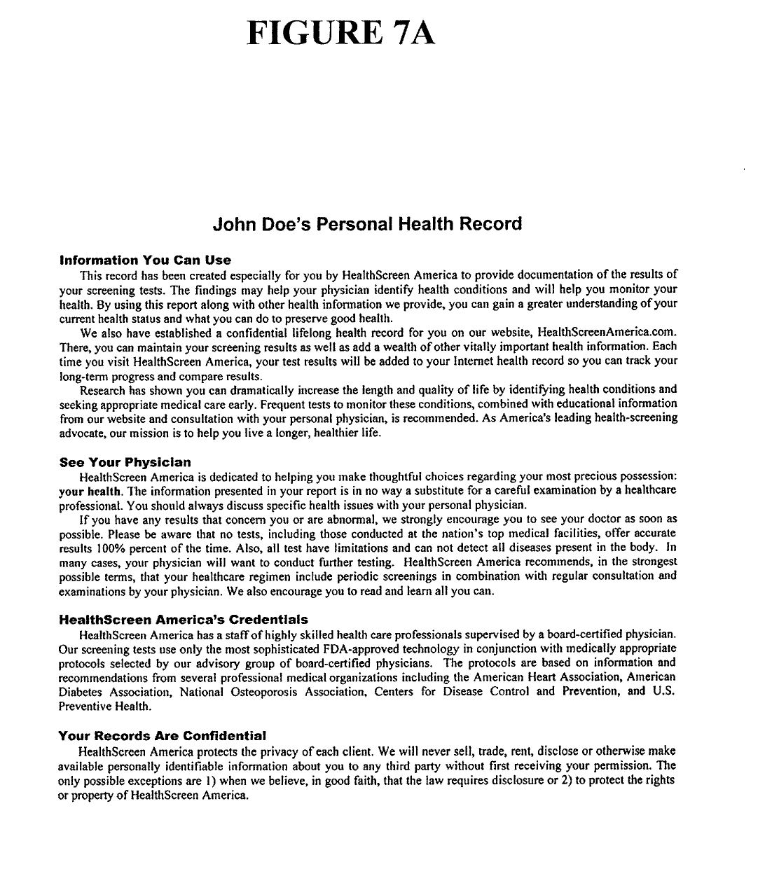

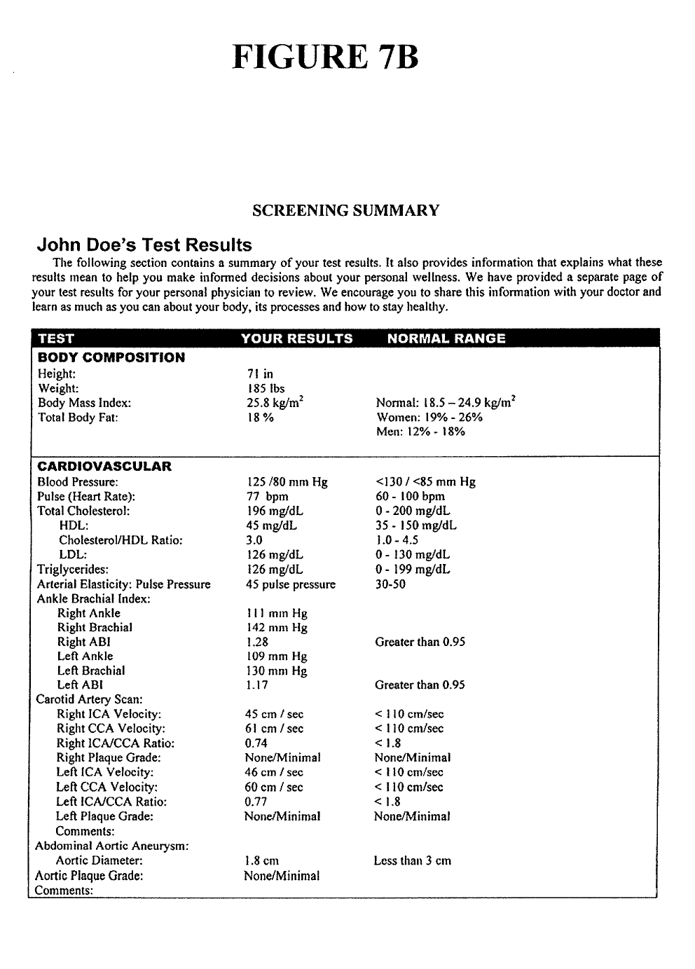

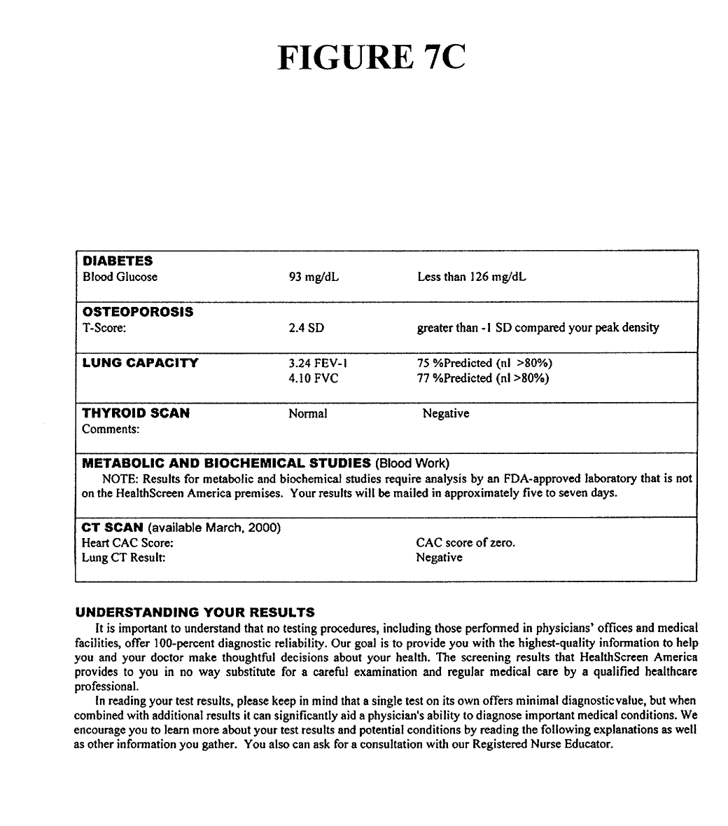

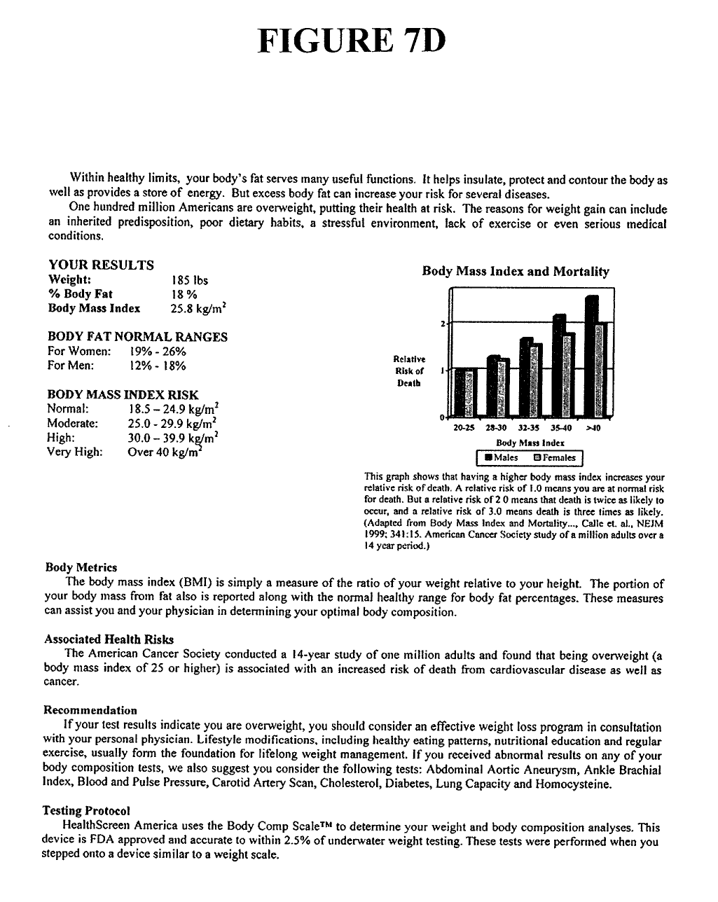

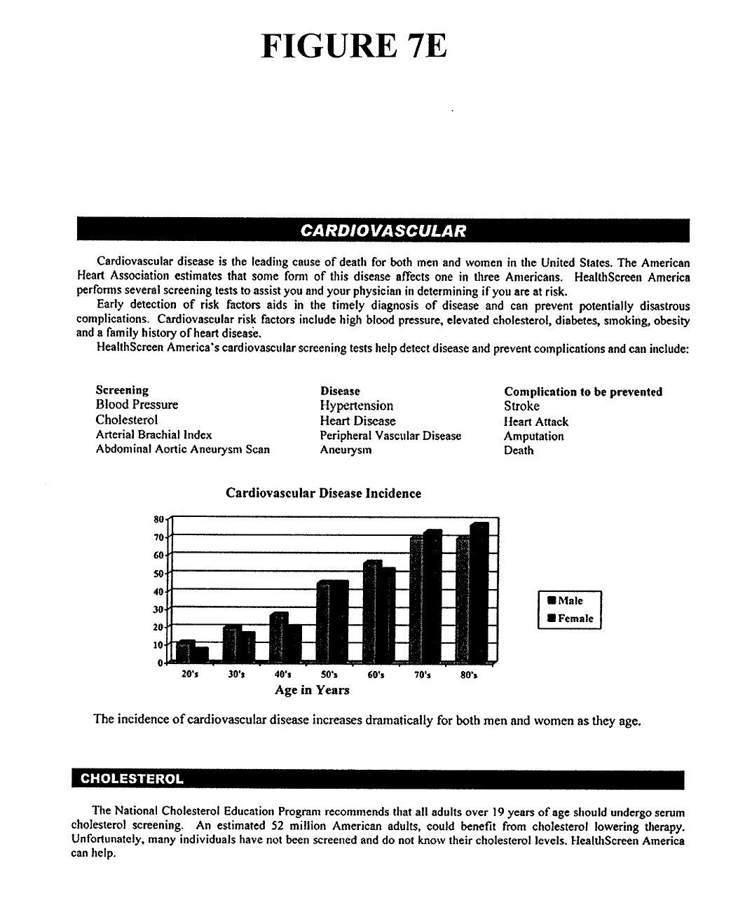

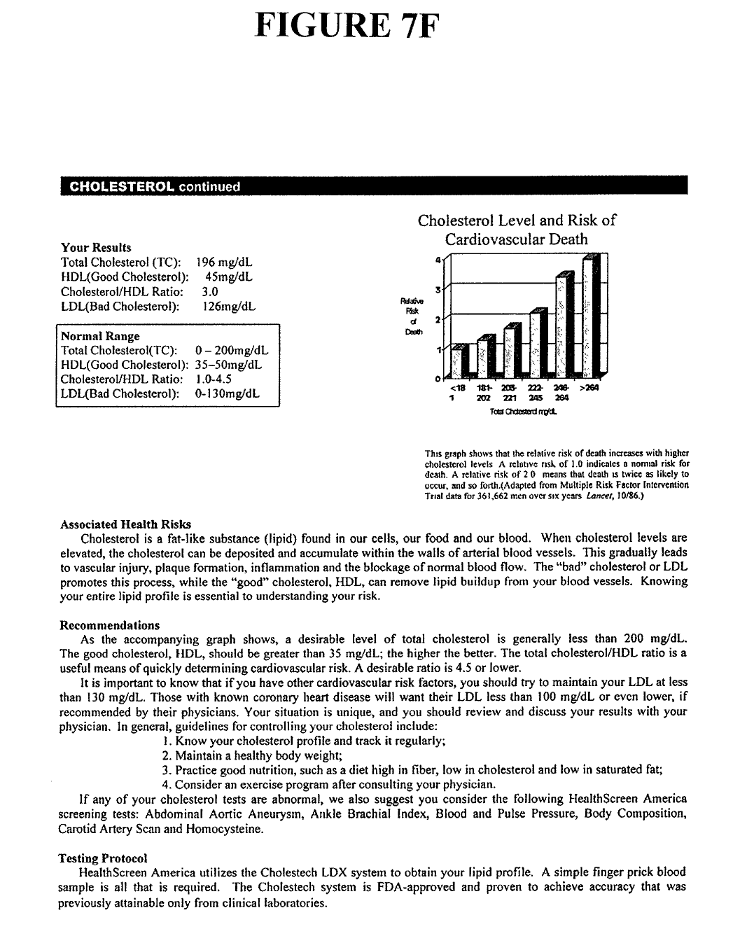

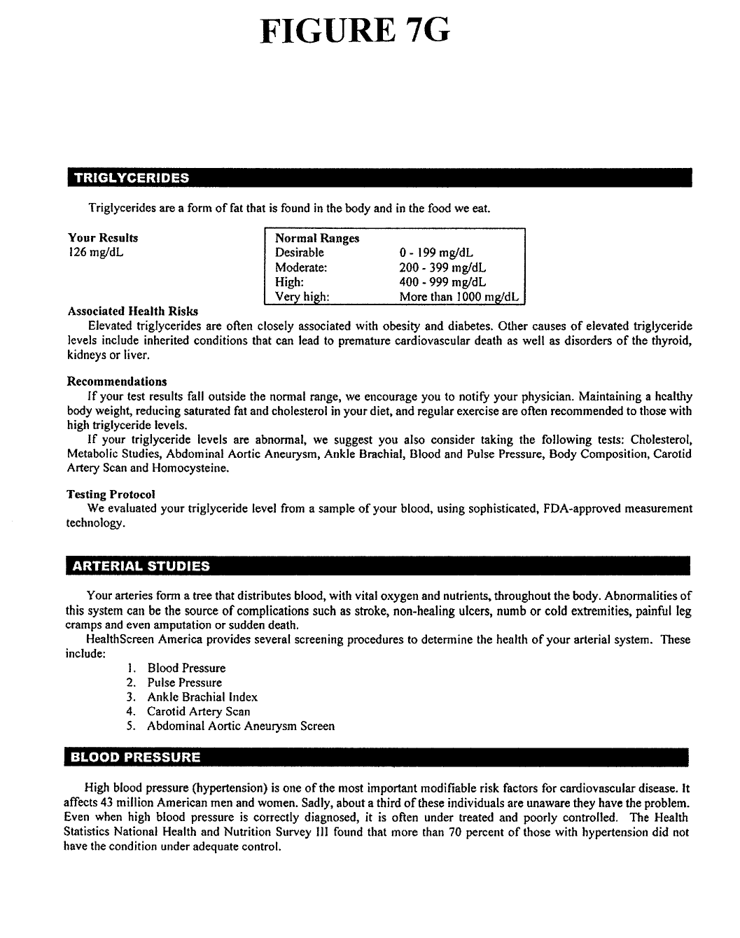

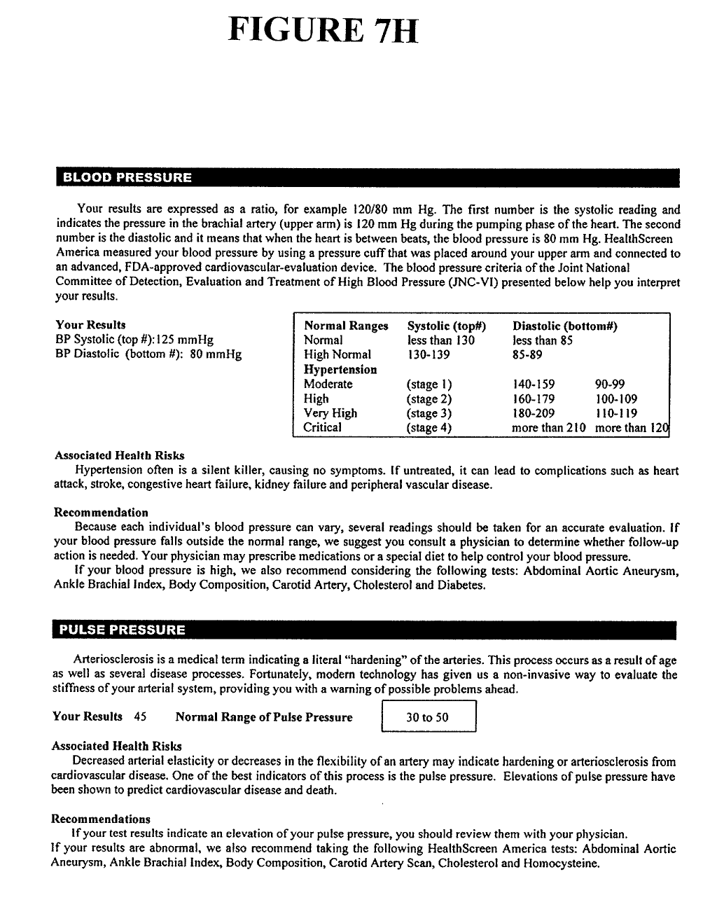

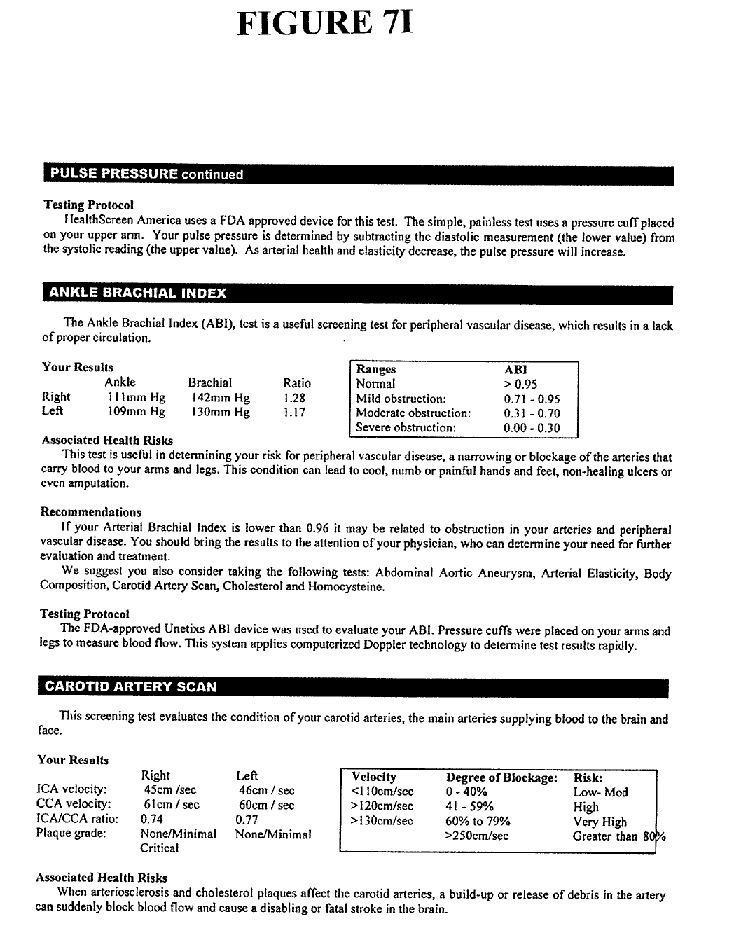

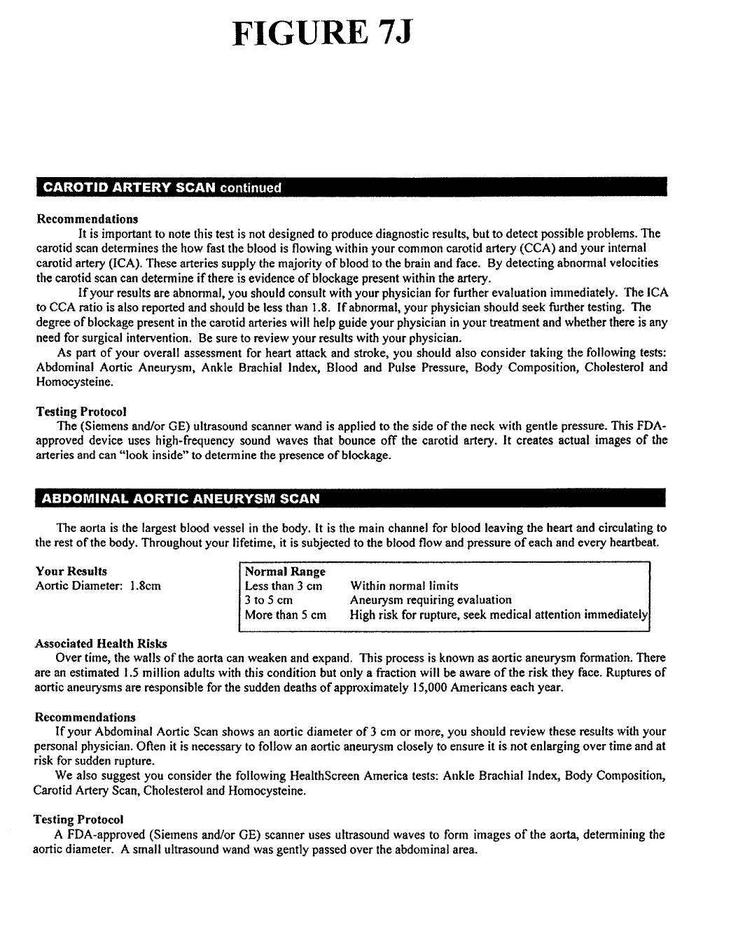

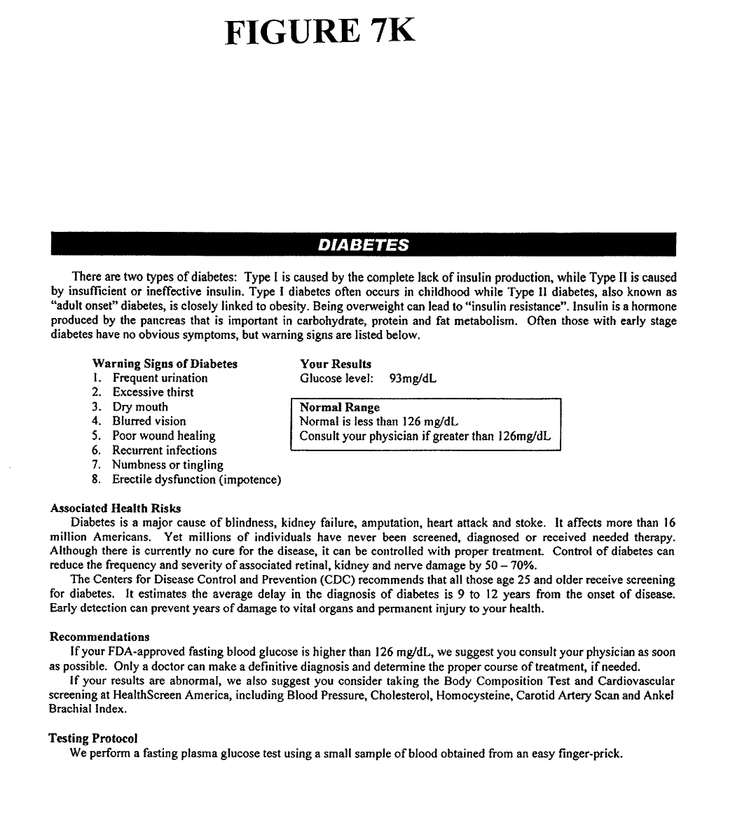

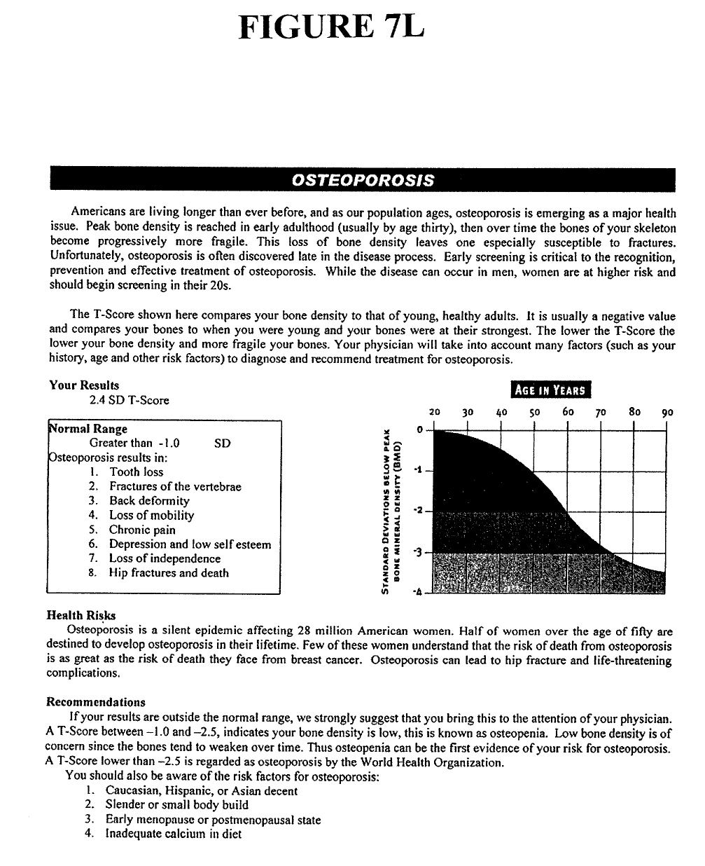

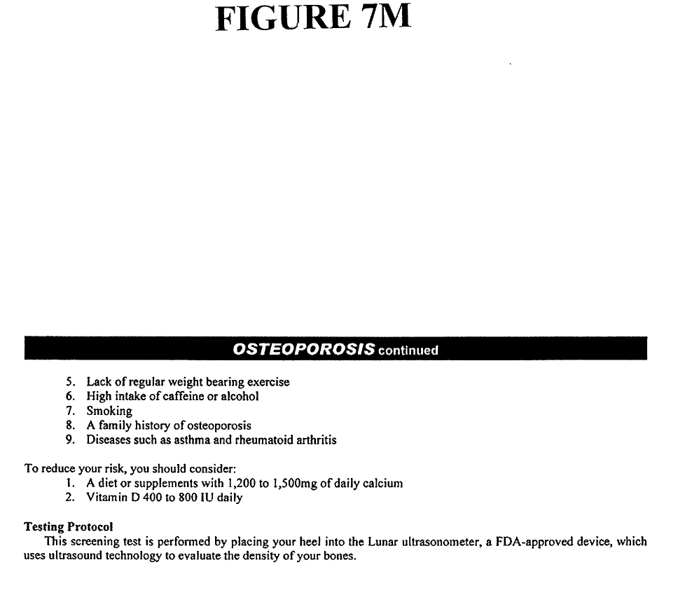

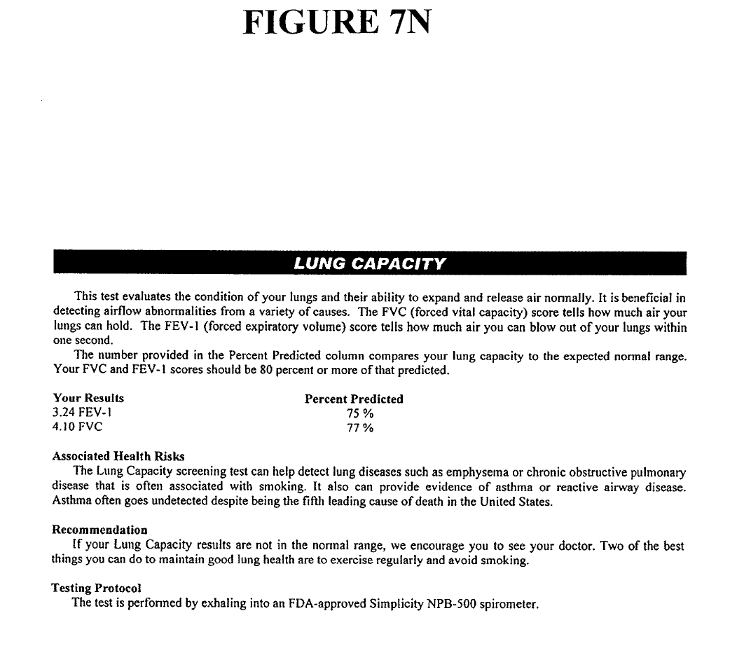

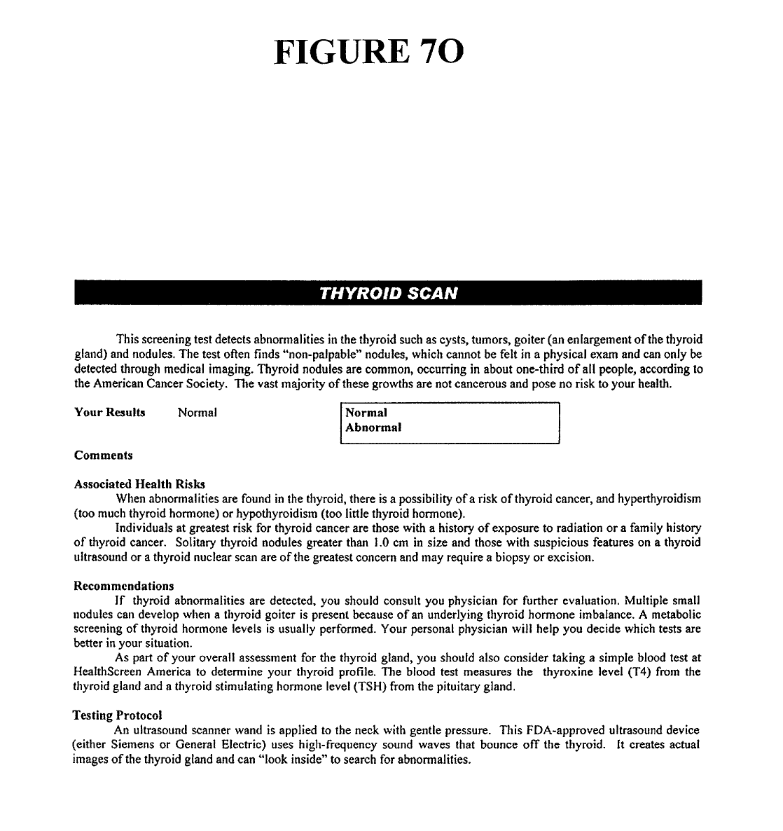

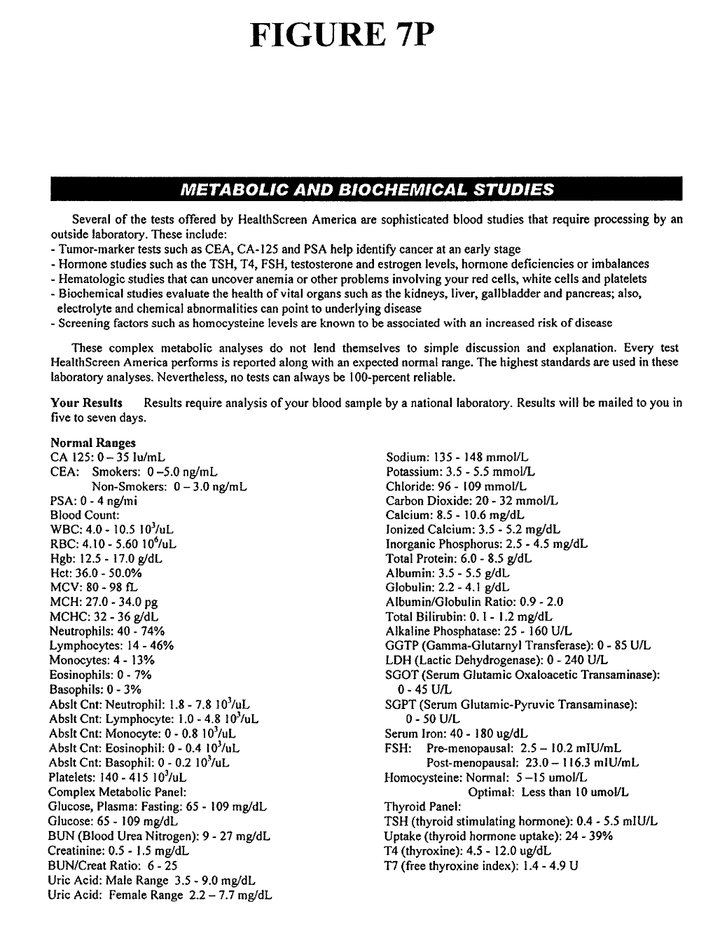

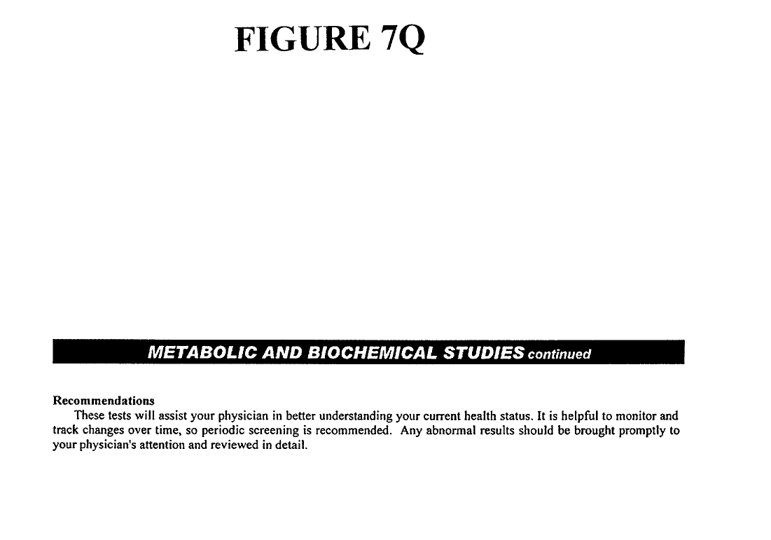

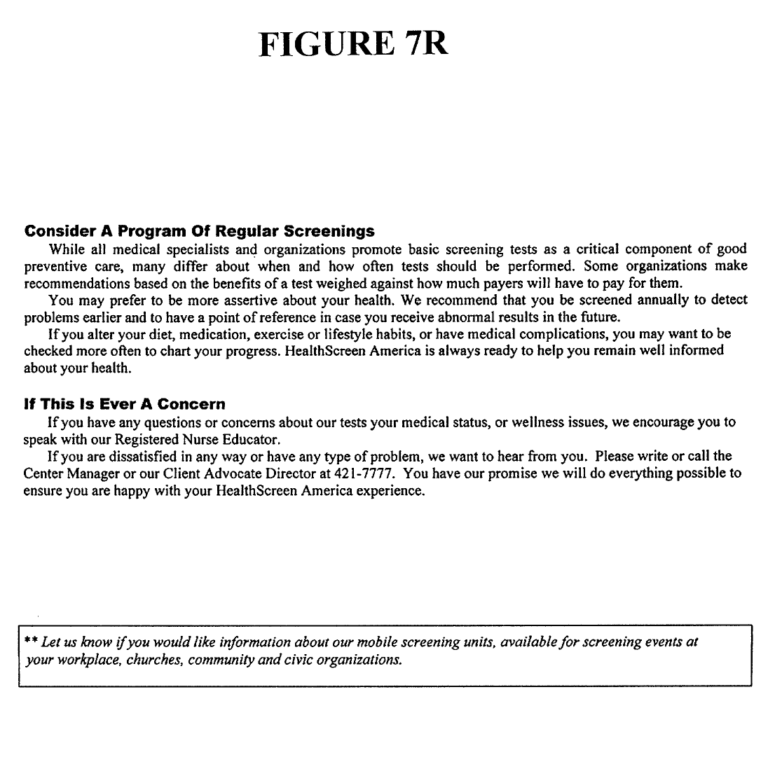

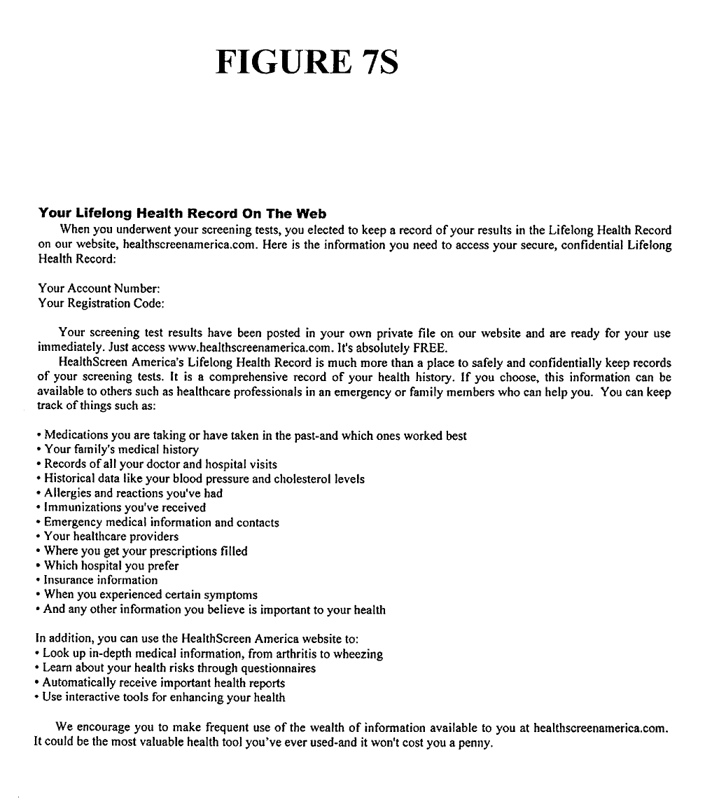

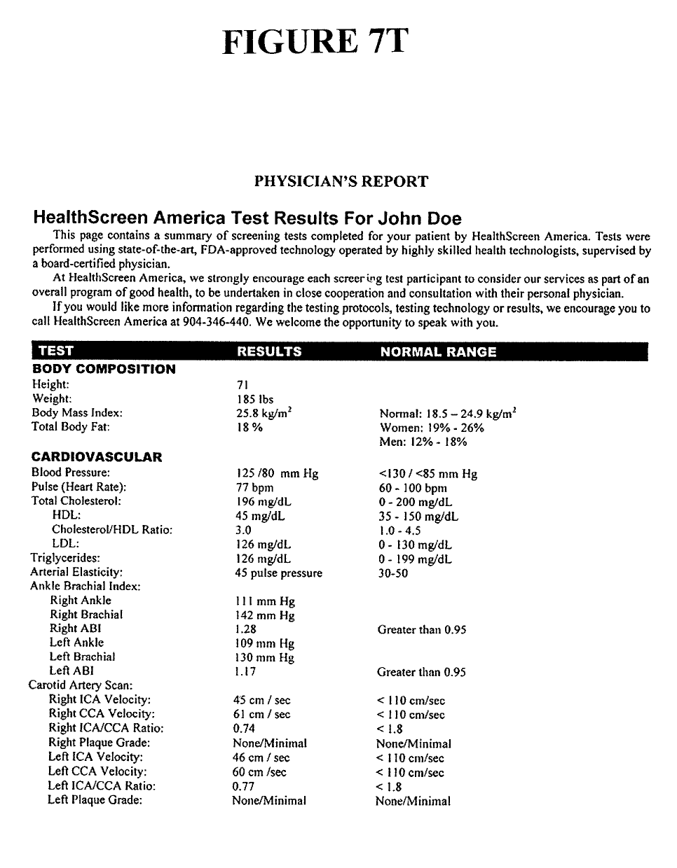

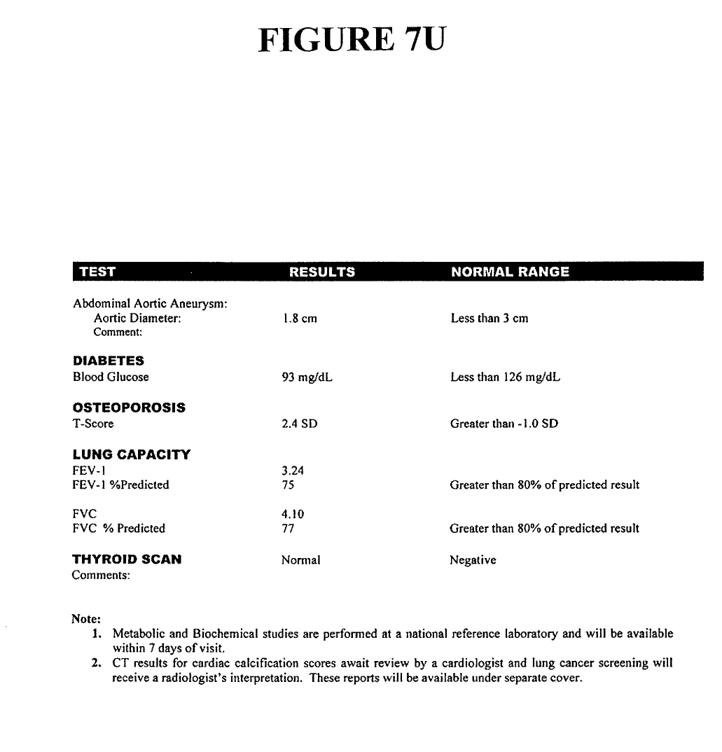

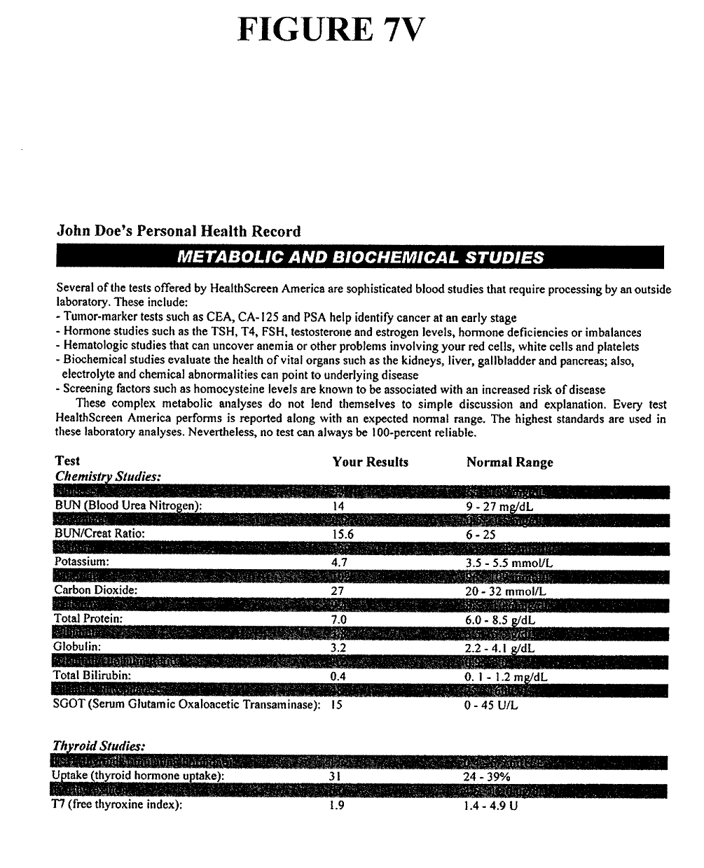

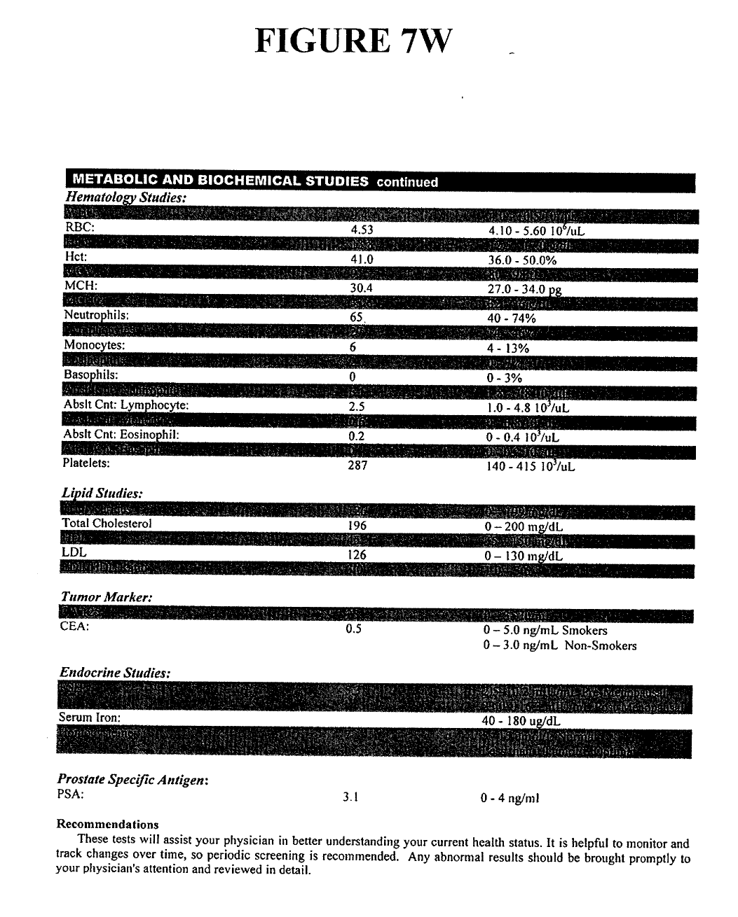

The database has three essential purposes. It stores individual data for consumers to allow them to have greater control over their health and well-being as well as greater, immediate access to their health records. FIGS. 7A-7W represent an example of a client report 16 including a detachable section for the client's physician. The report gives comprehensive explanations of each test offered and charts which clearly show the normal ranges for each test. Pre-formatted and scripted, the report takes only a few minutes to print as the database pulls the information needed from List Manager and the results from the tests taken.

The knowledge that consumers can take part in comprehensive health screening without incurring penalties from their insurance companies or employers frees consumers to become better informed and armed to fight off disease through early intervention. Viewing and fully understanding concrete test results often provides the needed catalyst to seek treatment and/or make positive lifestyle changes. Being able to access the reports immediately through the Internet provides a greater measure of security while traveling, if a medical emergency should arise. Immediate accessibility to the client's lifelong health record also makes changing doctors or seeking second opinions easier and faster than waiting for medical records from a physician's office.

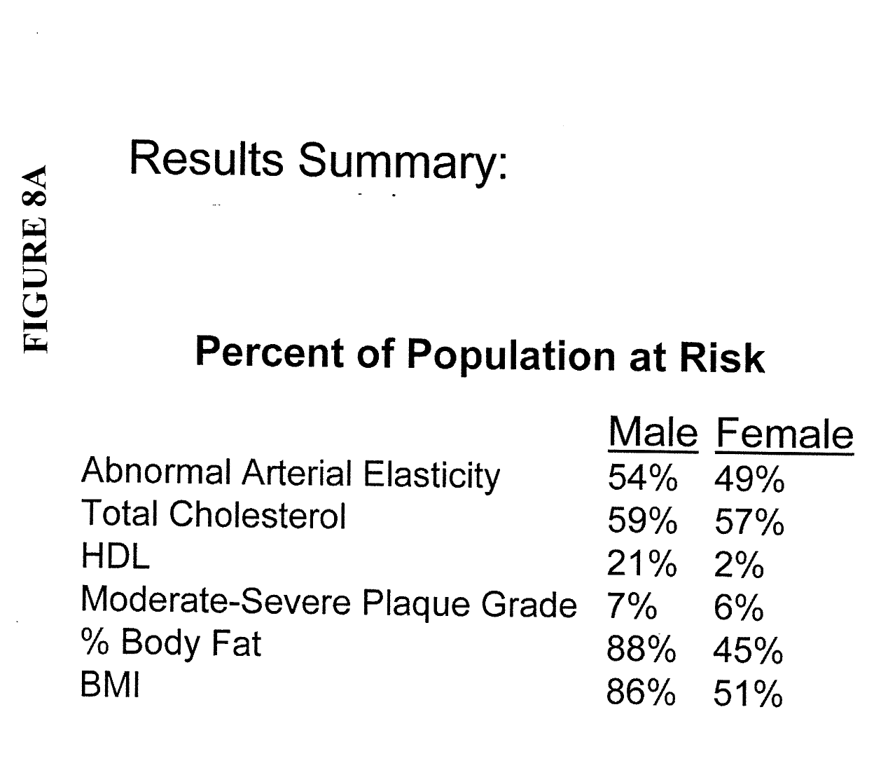

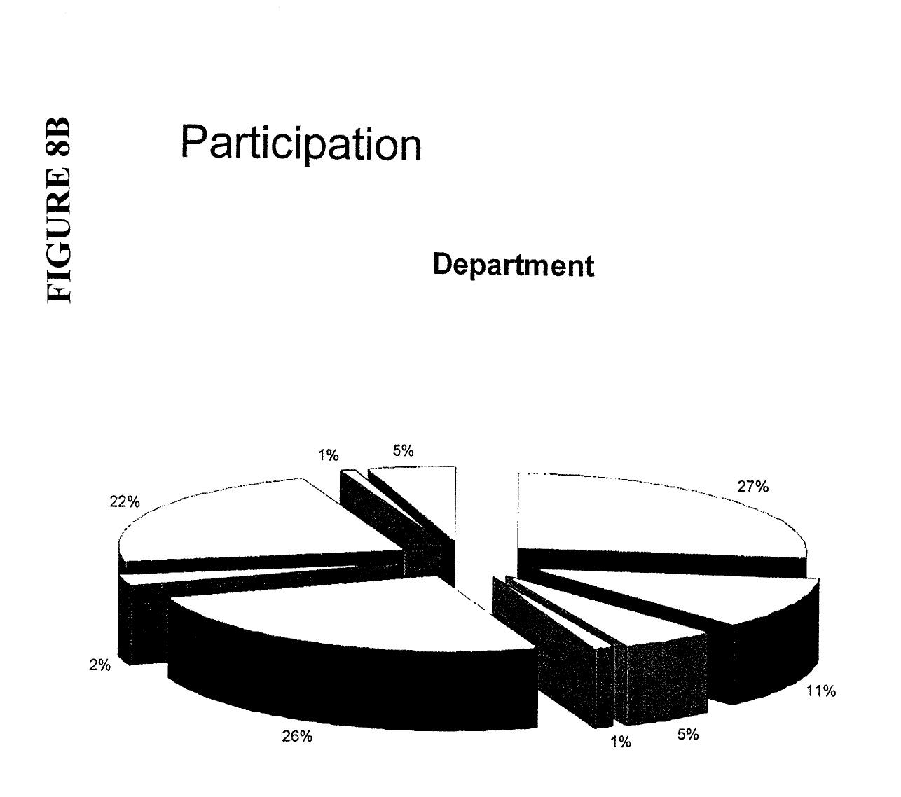

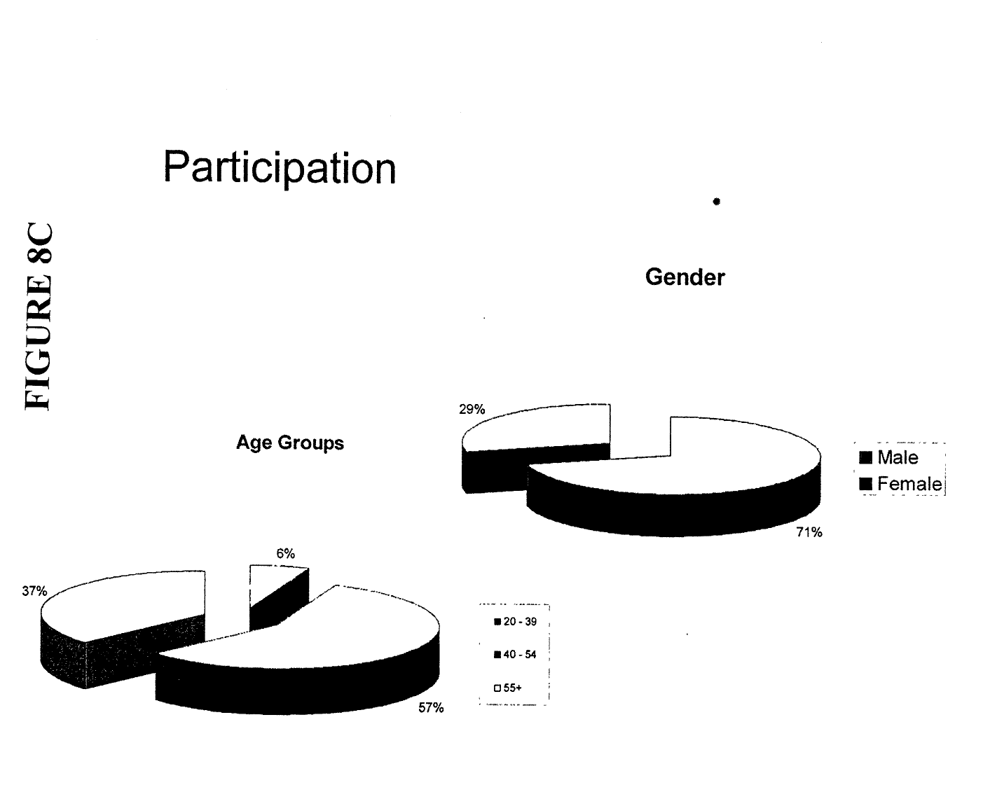

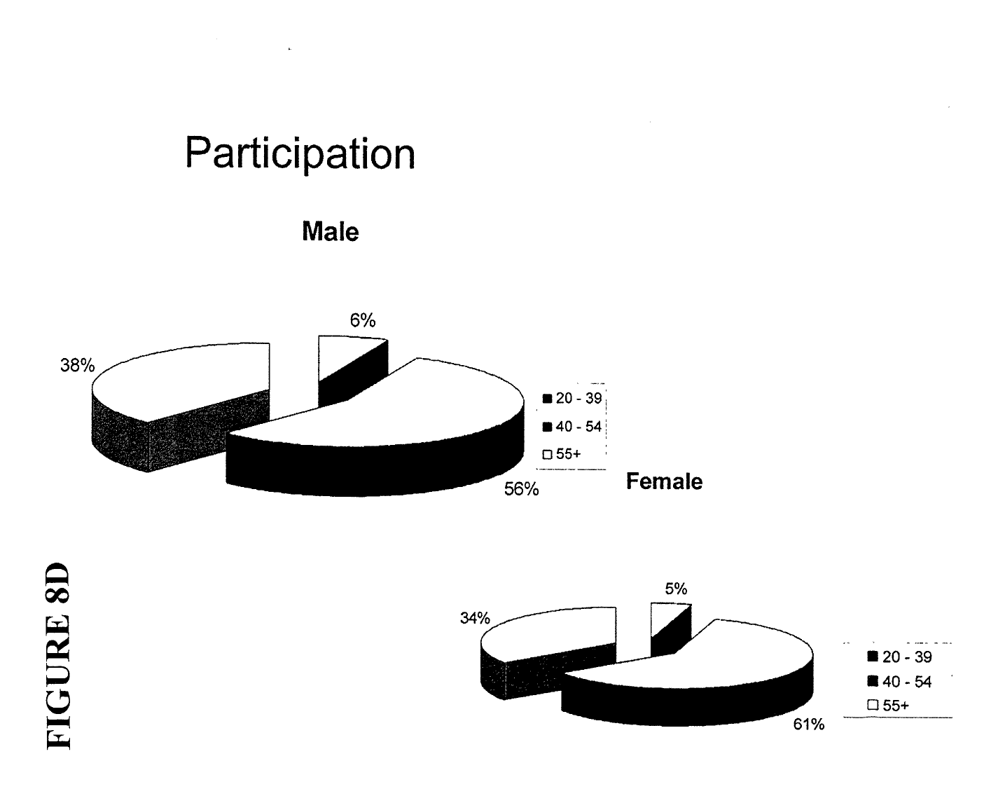

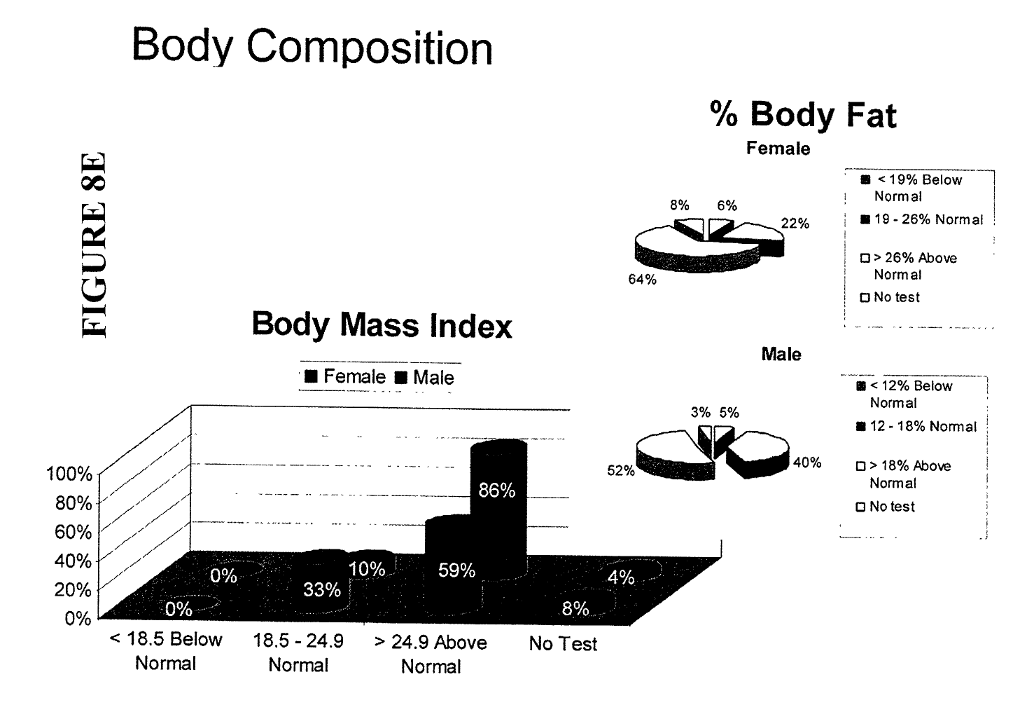

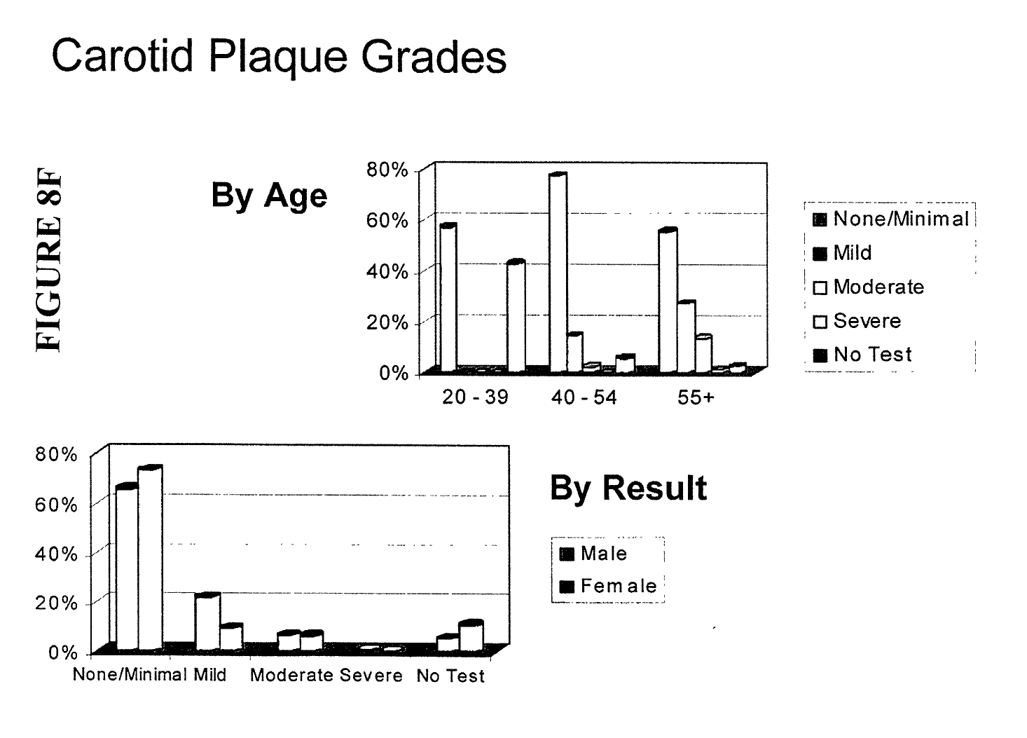

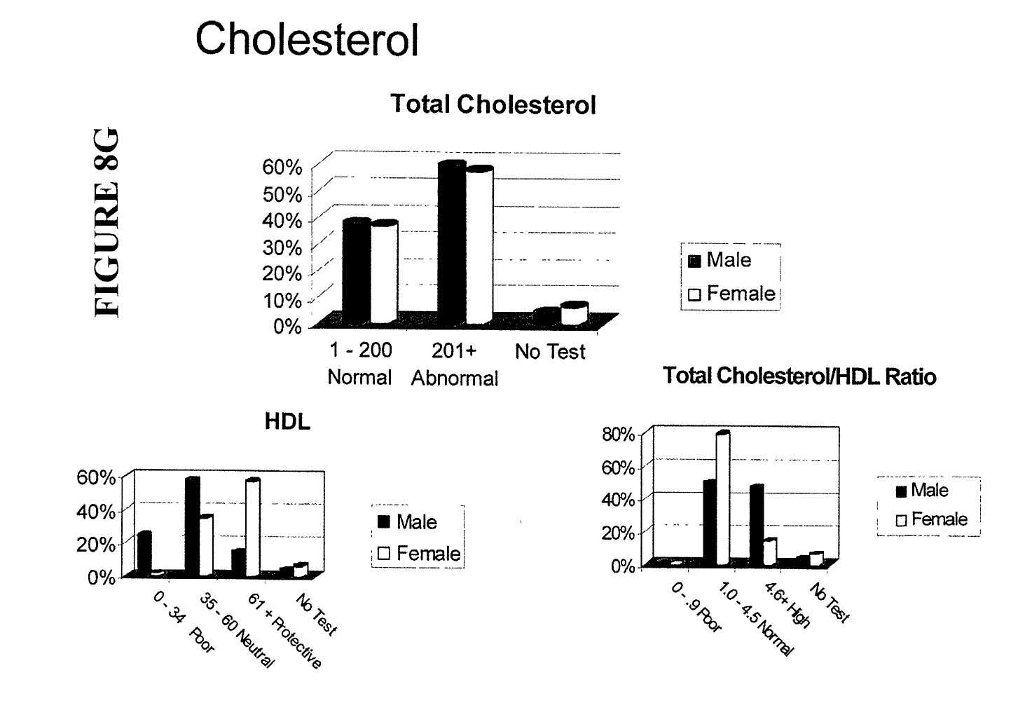

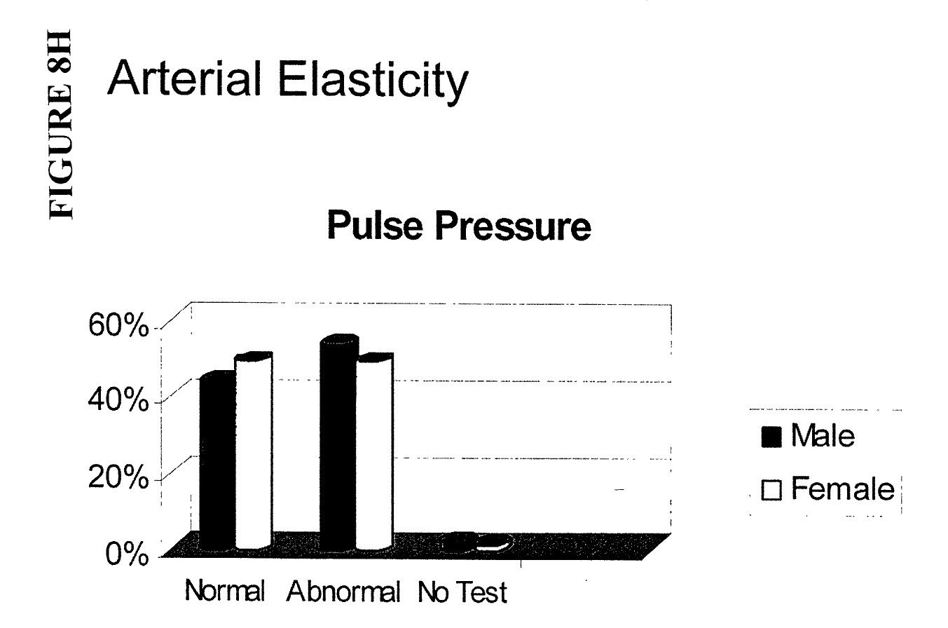

FIGS. 8A-8H represent an example of a printed Employer Summary Report (group report 17), which could be issued after a health event held for a company. The medical facility operating this system, method and program may choose to give such a report to the organization, along with individual reports given only to the individual participants. The employer summary report provides documentation on the overall fitness of the staff, without releasing any private information. It explains each test given, including the possible reasons for the condition and the normal ranges. This example breaks down the overall results of the tests by gender in chart format, showing percentages of those within specific ranges. Recommendations for further medical care or lifestyle changes are also included. Such a report, in print or electronic media, can help the organization develop a wellness program that will benefit more of their employees because it pinpoints the greatest needs. In turn, healthier employees experience less absenteeism and the organization's productivity increases.

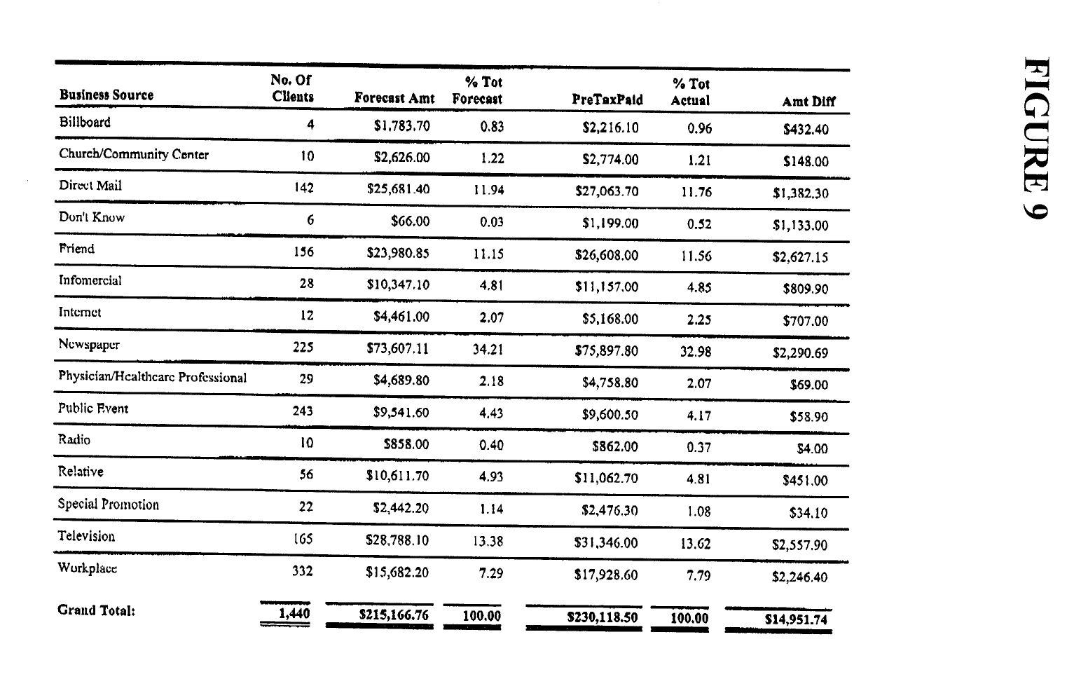

As screening data is collected from individual consumers, the aggregate of information may also be maintained for scientific research. FIG. 9 represents one sample aggregate information report generated by a preferred embodiment of the invention. This invention amasses critical data on a largely a-symptomatic population by storing all the medical and demographic information without any personal identifiers. That information can help the medical community develop trend data and risk assessments on a far wider population than has generally been available before. Up until now, most databases have information on patients who already have symptoms or full-fledged disease. In some cases, determinations of risk are based on a population that is largely deceased. Yet, we all know that people are living longer and healthier lives today. At the same time, some risk factors have increased. The United States has a greater percentage of obese people than at any other time in the last century. Moreover, the fastest growing segment of obesity is found in the under 21 population. Having more current information available to the medical community can translate into tremendous leaps forward in preventive care and early intervention.

Reports can be generated that detail risks according to location, age, gender and specific medical factors. Medical personnel can use that information to populate clinical trials with a cross-section of people at increased risk. To date, most clinical trials for preventive care rely upon advertising to the public in hopes of getting responses from those who are at greater risk. For instance, a large Tomaxofen study advertised for women who have had some family history of breast cancer. Researchers had to rely upon the accuracy of the women's memories, and, in some cases, stories repeated by family members but not experienced by the women, themselves.

A clinical trial based upon known evidence of risk factors could prove invaluable and produce more accurate results. For example, a clinical trial could use the more concrete criteria of at least 30% but not more than 45% calcified plaque in the coronary arteries to test medication for the prevention of heart attack. The database would generate a report based on the health screening of those participants who authorized information be released for clinical trials, and those people could be contacted directly by the medical personnel running the trial.

In addition, other reports can be generated, from those that show the source of business for the health-screening center (FIG. 9) to those that delineate overall results from all participants by test. A report can list the normal, abnormal and total for each test for a specific period of time. It can also show the abnormal result percentage for each test. This data can be used for trending forecasts and immediate risk assessments.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention. An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention. User input may be received from the keyboard, mouse, pen, voice, touch screen, or any other means by which a human can input data into a computer, including through other programs such as application programs.

It should be understood that the examples and embodiments described herein are for illustrative purposes only and that various modifications or changes in light thereof will be suggested to persons skilled in the art and are to be included within the spirit and purview of the claims.

What is claimed is:

1. A method of health data management, comprising the following steps, for each of a plurality of clients:
(a) collecting demographic information from a client, the client having assigned thereto a unique client identifier;
(b) conducting a medical screening on the client, wherein said screening comprises at least one test;
(c) storing results from said at least one test in a database;
(d) analyzing results in conjunction with risk factors associated with the client;
(e) generating a report for the client according to said analysis; and
(f) pre-populating an electronic health record for remote access by the client.

2. The method of claim 1 further comprising the step of combining the results of a plurality of clients to provide aggregate information and providing access to said aggregate information.

3. The method of claim 1 wherein the demographic information comprises: name, address information, gender, birth date, race.

4. The method of claim 1 wherein the step of conducting medical screening on the client comprises:
assigning a unique screening identifier for said medical screening and associating said client identifier therewith;
recording start time of said screening;
conducting at least one test; and
recording end time of said screening.

5. The method of claim 1 wherein the step of storing results from said test in a database comprises:
associating a unique identifier for each test taken by the client with said client identifier;
storing results wherein said results have assigned thereto a unique results identifier, said results identifier associated with said client identifier.

6. The method of claim 1 wherein the step of analyzing results in conjunction with risk factors comprises, for each of a plurality of risk factors, assigning unique identifier for said risk factor, establishing a risk assessment question associated with said risk factor, inquiring of the client said risk assessment question, storing response to said risk assessment question, determining positive or negative risk factor based on said response.

7. The method of claim 6 further comprising determining whether a client's age category is at risk for said risk factor.

8. The method of claim 6 further comprising determining whether client's gender is at risk for said risk factor.

9. The method of claim 6 further comprising determining whether client's race is at risk for said risk factor.

10. The method of claim 1 wherein the report generated for the client according to said analysis comprises:
a screening summary comprising test name, client results, and normal ranges;
a detailed report comprising educational information for each of said tests conducted during client screening, said educational information comprising test name, client results, normal ranges, associated health risks, recommendations, and test protocols; and
a physician's report comprising test name, client results, and normal ranges.

11. The method of claim 1 wherein the step of populating an electronic health record for remote access by the client comprises:
establishing a remotely accessible secure file for said client;
automatically storing demographic information collected from said client;
automatically storing test results for said client for each screening;
allowing client to update file with additional data;
allowing client to control access to data by others.

12. The method of claim 1 wherein said steps are performed for each of a plurality of clients in an organization wherein said organization has assigned thereto a unique organization identifier and said organization identifier is associated with each client who is a member of the organization.

13. The method of claim 12 further comprising assigning a unique department identifier for each department in said organization wherein said department identifier is associated with each client who is a member of the department.

14. The method of claim 12 further comprising collecting organization information, said information comprises: organization name, address, and number of clients in organization.

15. The method of claim 12 further comprising generating an organization report, said organization report comprising:
results summary showing percent of organization at risk for at least one category of health risks;
participation percentages by department, age groups, gender, and sex; and
detailed reports showing levels of risk by percentage of clients in each category.

16. A computer system for health data management, comprising:
input means for collecting demographic information from a client, the client having assigned thereto a unique client identifier, receiving and storing results in a database from at least one test conducted during a medical screening on the client;
processing means for analyzing results in conjunction with risk factors associated with the client and pre-populating an electronic health record for remote access by the client; and
output means for generating a report for the client according to said analysis.

17. A computer readable media containing program instructions for outputting data from a computer system, the data being obtained from tables in a database associated with the computer system, said computer readable media comprising:
first computer program code for collecting demographic information from a client, the client having assigned thereto a unique client identifier;
second computer program code for conducting a medical screening on the client, wherein said screening comprises at least one test;
third computer program code for storing results from said at least one test in a database;
fourth computer program code for analyzing results in conjunction with risk factors associated with the client;
fifth computer program code for generating a report for the client according to said analysis; and
sixth computer program code for pre-populating an electronic health record for remote access by the client.

18. A computerized storage and retrieval system for health data management comprising a data storage means for storing data in a relational database wherein the database comprises tables, each table having a domain of at least one attribute in common with at least one other table, said tables comprising:
at least one table for storing demographic information pertaining to a client;
at least one table for storing information pertaining to a risk assessment;
at least one table for storing responses to the risk assessment;
at least one table for storing risk factors for the risk assessment;
at least one table for storing information pertaining to client screening;
at least one table for storing common test information for tests that the client takes; and
at least one table for storing test results for tests that the client takes.

19. The computerized storage and retrieval system for health data management of claim 18 further comprising:
at least one table for storing organizational information pertaining to employers, groups, and event organizers;
at least one table for storing every organization associated with a client;
at least one table for storing information pertaining to an organization's departments; and
at least one table for storing every department associated with an organization.

20. The computerized storage and retrieval system for health data management of claim 18 further comprising:
at least one table for storing a risk/category matrix;
at least one table for storing age risk/category matrix; and
at least one table for storing race risk/category matrix.

21. The computerized storage and retrieval system for health data management of claim 18 further comprising:
a list manager for each test wherein each test has a test duration attribute.

22. A computer system for storing and retrieving health data comprising:
a relational database for storing data comprising a plurality of interrelated tables wherein each table comprises an attribute having a common domain with an attribute of at least one other table in the database; and
means for collecting and storing demographic information from a client in said database, the client having assigned thereto a unique client identifier;
means for conducting a medical screening on the client, wherein said screening comprises at least one test;
means for storing results from said at least one test in said database;
means for analyzing results in conjunction with risk factors associated with the client; and
means for generating a report for the client according to said analysis on the basis of the data stored in the relational database.

23. The computer system of claim 22 further comprising means for pre-populating an electronic health record for remote access by the client.

24. The computer system of claim 22, wherein the database comprises tables, said tables comprising:
at least one table for storing demographic information pertaining to a client;
at least one table for storing information pertaining to a risk assessment;
at least one table for storing responses to the risk assessment;
at least one table for storing risk factors for the risk assessment;
at least one table for storing information pertaining to client screening;
at least one table for storing common test information for tests that the client takes; and
at least one table for storing test results for tests that the client takes.

25. The computer system of claim 24, said tables further comprising:
at least one table for storing organizational information pertaining to employers, groups, and event organizers;
at least one table for storing every organization associated with a client;
at least one table for storing information pertaining to an organization's departments; and
at least one table for storing every department associated with an organization.
